(19) United States
(12) Patent Application Publication
(10) Pub. No.: US 2024/0316513 A1
(43) Pub. Date: Sep. 26, 2024

(54) METHOD AND APPARATUS FOR ON-SITE PREPARATION AND DOSING OF AN ENZYME-CONTAINING DETERGENT FORMULATION

(71) Applicant: CHRISTEYNS, Gent (BE)

(72) Inventors: Olivier MAREAU, Gent (BE); Simon LAMBERT, Gent (BE); Christian VERMOTE, Gent (BE); Franck DE MEULEMEESTER, Gent (BE); Stefaan BAELE, Gent (BE)

(21) Appl. No.: 18/574,586

(22) PCT Filed: Jun. 29, 2022
(86) PCT No.: PCT/EP2022/067982

§ 371 Date: Dec. 27, 2023

(30) Foreign Application Priority Data
Jun. 29, 2021 (EP) 21182317.4

(51) Int. Cl. B01F 33/84; B01F 23/40; B01F 35/22; B01F 35/88; B01F 101/00; C11D 1/75; C11D 3/386; C11D 11/00

(52) U.S. Cl. CPC B01F 33/846; B01F 23/483; B01F 23/49; B01F 35/2205; B01F 35/881; C11D 1/75; C11D 3/38627; C11D 11/0094; B01F 2101/4505

(57) ABSTRACT

Disclosed is a method for the preparation and supply of an enzyme-containing detergent formulation, the method comprising the steps of: a transferring from a plurality of feed sources (3a to 3f) the ingredients required for forming a batch of the detergent formulation into a mixing vessel (25), b mixing the ingredients to form the batch, c discharging the batch from the mixing vessel, d by pumping supplying at least a part of the batch to at least one treatment device (42), wherein at least one feed source is comprising an enzyme-containing concentrate, wherein the preparation is performed on-site with the treatment device, and wherein the amounts supplied of the batch and of the enzyme concentrate as part of the batch are determined by weight. Also disclosed is an apparatus (41) for on-site with the treatment devices (42) preparing and supplying the detergent formulation.

### FIELD OF THE INVENTION

The present invention relates to the on-site preparation and supply of washing and/or cleaning formulations to one or more devices that are using the formulations in a washing or cleaning step, in particular the formulation comprising enzymes. The invention is further capable to provide for a safe and accurate preparation method and suitable apparatus for preparing the detergent formulations on-site and for accurately supplying the formulations safely towards the treatment devices to which the apparatus is preferably connected. This dosing system is in addition automatically readjusting its dosing times based on recent dosing experience, and provides a reliable report about the delivery of the dosed ingredients. The system is thus offering an improved safety, security and reliability to the end-user.

### BACKGROUND OF THE INVENTION

The use of enzymes in washing and cleaning agents is established in the existing art. They serve to expand the performance spectrum of the relevant agents in accordance with their specific activities.

Enzymes are three-dimensional protein structures that exhibit activity as biocatalysts, i.e. substances that accelerate chemical reactions. The enzymes are thus not consumed in the chemical reaction, but afterwards come free again, available to engage again in a subsequent reaction. Enzymes are usually limited in the number of reactions that they have evolved to catalyse. The molecules upon which enzymes may act are called substrates, and the enzyme converts the substrates into different molecules known as products.

Enzymes are typically very specific in the type of substrate they are active upon, and are often named after that type of substrate. A protease is an enzyme that is able to breakdown proteins into smaller polypeptides and/or single amino acids. Many commercial forms of protease exist in the form of enzyme concentrates, such as Savinase®, Liquanase®, Coronase® (from Novozymes), Optimase®, Preferenz® (from DuPont), and Lavergy® (from BASF). Lipase catalyses the breakdown of triglycerides, also called “lipids”. α-Amylase catalyses the hydrolysis of starch into di- and trisaccharides. Other forms of amylase, also called mannase or mannanase, catalyse the breakdown of oligosaccharides into sugars. Pectinase, e.g. pectin lyase or pectolyase, degrades residual fruit starch, known as pectin. Cellulases are able to degrade cellulose, e.g. cell walls. These enzymes, including lipase, are commonly used in laundry and dishwashing detergents.

Most commonly used are hydrolytic enzymes such as proteases, amylases, lipases, and cellulases. The first three of these hydrolyse proteins, starch, and fats, respectively, and thus contribute directly to stain removal. Cellulases are used in particular because of their fabric effect. A further group of washing- and cleaning-agent enzymes includes the oxidative enzymes, in particular oxidases that either alone or in interaction with other components serve to bleach surface stains or generate bleaching agents in situ. In addition to these enzymes, which are the subject of continuing optimization, other enzymes are constantly being made available for use in washing and cleaning agents to address specific stains. These additional enzymes include pectinases, β-glucanases, mannanases, or additional hemicellulases for the hydrolysis of specific plant polymers.

A problem with enzymes in detergent formulations is thus that they are selective to the type of soil that they are able to act upon. The degree of surfactant replacement in the formulation that may be achieved by adding enzymes into the washing or cleaning liquor is thus strongly dependent on the types of soil that the washing or cleaning service is expecting for treatment. For a particular job, it may thus often be desired to employ a cocktail of enzymes, e.g. to attack all of protein stains (such as blood stains), starch stains and fat stains. A minimum level of surfactant may in addition be included in the formulation, to also attack the types of soil for which no suitable enzyme was included, in order to achieve a higher level of assurance about the results to be obtained.

One enzyme type that is particularly of interest in the context of washing and cleaning are the lipase enzymes. A lipase enzyme is defined in the art as “any enzyme that catalyses the hydrolysis of fat (lipids)”. The lipase enzyme is thus highly desired for attacking “fat stains”, i.e. stains containing a triglyceride. The enzyme typically converts the triglyceride molecule into one monoglyceride and two fatty acids, i.e. reaction products that more readily dissolve in the washing liquor and thereby may be removed from the substrate.

The lipase enzymes however have a particularly strong compatibility and/or interference problem with many of the surfactants that may be used in detergent formulations. They are much more sensitive to surfactants than the other enzymes of common use in laundry and dishwashing.

The inventors have further found that the combination of lipase enzymes with other enzymes, e.g. with protease, and/or with many surfactants, in an aqueous environment rather quickly leads to the formation of a deposit, in particular when all components are still in a concentrate that is prepared as an intermediate intended for being added to the treatment liquor. Such a formulation is therefore usually not stable.

WO 2009/019075 A1 is concerned with the problem of incompatibility of different enzymes, in particular whereby protease is one of the major components of an enzyme blend, due to hydrolysis of the other enzyme components. The document proposes a fabric washing process in which fabric is treated sequentially with two different enzymes, proteases in the first step and in the second step a second enzyme of a different family than the proteases of the first step. Between the steps there may be a time delay or another process step such as a rinse step. This method has the drawback that it is more time consuming, which makes it unsuitable for an industrial setting, and is therefore limited to a domestic and consumer household environment.

Enzymes are products of biochemical processes. They are usually produced by bacteria. The industrial processes for their production require tight control and conditions of high cleanliness in order to assure the selectivity that is required to obtain a concentrate of usually one particular enzyme, occasionally a combination of two or more. The industrial production of enzymes is practiced by only a limited number of players who have invested significantly in the development of a number of different enzyme concentrate products and the corresponding production processes. Industrially produced enzymes are thus only available at a significant economic premium relative to most surfactants.

Incorporating one or more enzymes into a washing or cleaning agent thus comes at a significant expense for the formulator, in spite of the catalytic role which the enzyme performs in the treatment process. The latter implies that small quantities of the enzyme are able to generate large effects. In agents intended for the general consumer and for household use, where washing and cleaning is allowed to take long treatment times and where performance is typically not a prime criterion for the selection of the treatment agent, a very small presence of a particular enzyme concentrate may be sufficient to obtain a noticeable result, and hence the high cost of the enzyme concentrate may remain more readily affordable.

Washing and cleaning in an industrial context is however governed by distinctly different criteria. Industrial washing and cleaning processes typically operate with much shorter treatment times. Laundry washing has to be over in minutes rather than the typical one hour or more that is acceptable in a household setting. The times of industrial dishwashing processes is often even expressed in seconds. The performance of the treatment agent is also a very important if not the determining factor for its selection. In an industrial context, the cleanliness of the treated surface or substrate is in many instances of paramount importance. Industries such as the food, cosmetic or pharma industry, or medical and/or hospital environments, cannot afford any failures in the delivery of excellently cleaned textiles and surfaces.

An industrial provider of washing or cleaning services is therefore on the one hand highly concerned with the effectiveness of the treatment agent that he uses. He wants to be sure that the agent undoubtedly delivers impeccable results, in spite of the high processing speeds and the short treatment times. This concern points in the direction of highly concentrated treatment agents, also with respect of the enzymes. On the other hand, he is also concerned with the costs of his services, and thus with the efficiency of his treatment agents. The enzyme concentrates being the more expensive ingredients, he is thus highly concerned about the number and amounts of enzyme concentrates that are used in each one of his treatment agents. He thus wants to avoid using more of each enzyme than necessary. Equally important, he also wants his treatment agent to be tuned to the type of soil or dirt that needs to be removed, and wants to avoid the use of an enzyme for which the treatment has no real need.

A provider of washing or cleaning agents thus has a strong desire to adapt the washing or cleaning liquor for his treatment, and in particular to adapt the cocktail of enzymes therein to the type of dirt that is expected on the textile or surface that needs to be cleaned. The property relating to the type of dirt in dirty laundry is often called “the classification”, and it is often used to differentiate laundry types, e.g. it allows to distinguish between hotel linen and healthcare linen. The classification also defines the washing process that should preferably be applied in order to be most effective as well as most efficient. The larger industrial providers of textile cleaning may even have several washing tunnels and may dedicate particular washing tunnels to particular classifications of laundry.

Another problem with enzymes in detergent formulations is that the combination of enzymes with surfactants often leads to instabilities of the formulations, whereby e.g. deposits may form. These formulations often need to be stabilized by the addition of so-called “stabilizers”, often glycol or other polyols. These stabilizers represent an additional cost to the formulator and also increase the environmental load of the washing or cleaning process in which the formulation is used. The extra “chemical oxygen demand” (COD) or other environmental burden that the stabilisers contribute to the waste water of the process gives rise to extra environmental loads, and may for industrial providers of washing and cleaning services lead to extra taxes imposed by their governments.

Lipase also turns out to be a highly sensitive enzyme with respect to the type of surfactants in the formulation, in particular to the family of linear alkyl sulphates (LAS), a type of surfactant that is very popular in laundry washing formulations.

It is far from straightforward to stabilize the lipase and other enzymes in the formula, but the stabilization is required in view of the time that may elapse, as part of the supply chain of the conventional supply system, wherein the laundry detergent formulation is produced by a detergent supplier in a location that is remote from the location of the washing process in which the formulation is used. For this reason the use of lipase enzymes into industrial textile laundry and other washing and cleaning operations has remained very difficult.

There therefore remains a need for a method that avoids or reduces the need for stabilisers in enzyme-containing washing or cleaning agents, in particular in the agents that are supplied to industrial washing and cleaning processes and which comprise enzymes.

WO 2017/211698 A1 is concerned with the problems of incompatibility and degradation of laundry product ingredients such as enzymes, in particular that certain enzymes cannot be stored in combination. The document proposes a dispensing unit that may even be integral to a washing machine intended for use in a consumer household setting. The dispensing unit comprises at least 5 reservoir cartridges in controllable fluid communication with at least one nozzle through which the ingredients are dispensed into the wash liquor in the washing machine, or into a dosing unit when stand alone, optionally via a pre-mixing chamber or area in which two or more ingredients may partially be mixed prior to dispensing and be diluted to provide a wash liquor. A first reservoir is comprising a base surfactant, a second reservoir a first enzyme, e.g. protease, optionally further comprising sodium lauryl ether sulphate (SLES) to boost detergency, a third reservoir comprising a second enzyme different from the first enzyme, a fourth reservoir a bleach component and a fifth reservoir an alkaline component. The device dispenses from one or more reservoirs or cartridges to provide a laundry product or to obtain a wash liquor as a result of input by a user. Flow from the reservoir to the nozzle is controlled by a metering valve, with the metered volume being controlled by a computer module. WO 2019/149707 A1 proposes to provide to each ingredient reservoir of the dispensing unit an ingredient reservoir identifier such as an RFID device or “tag”, and to provide a RFID reader as part of the control system in the device. The devices proposed by WO 2017/211698 A1 and WO 2019/149707 A1 operate on a volumetric basis. They may be suitable for a consumer household setting, but they are not suitable for washing and/or cleaning services in an industrial setting, because these require accounting level accuracy and reliability.

Another problem with enzymes is industrial hygiene. Aerosols of formulations containing enzymes are known human sensitizers, and exposure to personnel and other people should be avoided. The preparation of a washing or cleaning liquor, or any intermediate thereof, that is containing enzymes should thus be performed in closely controlled circumstances and conditions. Assuring the conditions that are able to avoid direct human contact with enzyme containing products in every industrial washing and/or cleaning environment is however a very difficult task. It is indeed not sufficient to provide high quality packaging for the enzyme containing ingredients, because such packaging needs to be opened and handled in order to prepare the washing and/or cleaning liquor, or an intermediate therefore.

There therefore remains a need for improving the safety and industrial hygiene in the logistics chain that is leading up to the provision of an enzyme-containing washing and/or cleaning liquor, in particular concerning the possible exposure of humans to aerosols containing enzymes.

EP 3137235 B1 describes a method of hard surface cleaning comprising the step of spraying the surface with an enzyme-containing (e.g. lipase) composition at a pressure of at most 7 bar for preventing the formation of an aerosol mist of the composition. The applicants however believe that the measures proposed in this document bring only a limited beneficial effect in terms of the safety of the personnel involved in the operations.

Yet another problem with enzymes is their correct dosing in the textile washing process. For washing an amount of 50 kg of linen, depending on the classification of the laundry, the optimum dosing of the enzymes may range anywhere from 1.6 to 80 grams (0.032 g/kg to 1.6 g/kg) total of all enzyme concentrates together. Because of the high cost of the enzyme concentrates, overdosing of the enzymes would lead to excessive operating cost. On the other hand, a too low dosing of the enzymes, also called “a short dosing”, would risk a failure to obtain the required cleaning performance.

A correct dosing with the correct types of enzyme is therefore of paramount importance for a reliable and affordable washing and/or cleaning operation in an industrial setting.

WO 2008/078075 A2 describes an apparatus for delivering a fluid to a location, or a plurality of fluids to a plurality of locations, using a positive displacement (peristaltic or “roller”) pump, whereby the apparatus assures a more correct dosing thanks to a flaccid intermediate reservoir having a variable volume that is squeezed between two plates of which one is pressed with a substantially constant force, which is believed to put the reservoir under a substantially constant pressure. The reservoir should have a maximum volume V-max and a minimum volume V-min, whereby the ratio V-max to V-min may be at least 100. The purpose of the apparatus is to deliver from the intermediate reservoir by means of the positive displacement pump a fluid and/or liquid colorant for a plastics material into a plastics shaping process, e.g. an injection moulding machine or an extruder. The described apparatus does not have the capability of formulating a composition by mixing different ingredients with each other in order to obtain a liquid formulation for being delivered. The delivery of the fluid from the apparatus occurs on a volumetric basis.

A further need remains for a method that may offer the capability for adapting the enzyme cocktail in the washing or cleaning agent to the treatment step for which it is intended, to the type of surface or substrate that is to be treated and to the types of soil and dirt that is expected on the surface or substrate, e.g. to the “classification” of the linen to be treated. The method should preferably offer the capability to change the selection of the enzymes that should go into the treatment agent, and also be able to adapt the dosing of particular enzymes in accordance with the level of particular types of soil and/or dirt.

A further need remains for a correct, safe and reliable dosing system for the enzyme cocktail that is appropriate and adapted for the selected washing or cleaning process. A further problem is to continue providing these properties of safety, accuracy and reliability over an extended period of time and with a minimum of support from the end-user. A further problem is to fully automate the delivery process up to the issuing of a correct and reliable invoice for the supplies delivered to the end-user.

The present invention aims to obviate or at least mitigate the above described problem and/or to provide improvements generally.

### SUMMARY OF THE INVENTION

According to the invention, there is provided an apparatus, its use, and a method as defined in any of the accompanying claims.

In an embodiment, the present invention provides an apparatus for the on-site preparation and supply of at least one enzyme-containing detergent formulation, comprising
at least one mixing vessel for forming a batch of the detergent formulation,
at least one feed device, preferably a plurality of feed devices, each feed device being connected on the supply side to a feed source and on the delivery side to the at least one mixing vessel for feeding the ingredients for the detergent formulation,
at least one discharge vessel connected to the at least one mixing vessel for receiving and storing the batch of the at least one detergent formulation,
at least one discharging device provided for supplying under pressure the at least one detergent formulation stored in the at least one discharge vessel,
   wherein at least one of the feed sources is containing at least one enzyme concentrate preferably comprising at least one enzyme that is capable of exhibiting detergent activity,
   wherein the at least one discharge device is equipped with a pump and connected on the delivery side to at least one treatment device suitable for applying the detergent formulation by treating at least one object, preferably a textile or food-related object, and the at least one discharge device is equipped for supplying at least a part of the formed batch of detergent formulation to the treatment device,
   characterized in that the at least one mixing vessel is equipped for forming the batch of the detergent formulation having a predetermined amount by weight, and comprising a predetermined amount by weight of the at least one enzyme concentrate, and
   the at least one discharge vessel is provided with a level sensor for at least detecting a low level in the discharge vessel.

In another embodiment, the present invention provides a method for the preparation and supply of at least one enzyme-containing detergent formulation comprising an amount of at least one enzyme concentrate as an ingredient, whereby the method is using the apparatus according to the present invention, the method comprising the steps of:
a. transferring from a plurality of feed sources the ingredients required for forming a batch of the at least one detergent formulation into a mixing vessel,
b. mixing the ingredients in the mixing vessel to form the batch of the at least one detergent formulation,
c. discharging the batch of formed detergent formulation from the mixing vessel,
d. by pumping supplying at least a part of the batch of the at least one detergent formulation to at least one treatment device,
   characterized in that at least one feed source is comprising, and preferably is, an enzyme concentrate preferably comprising at least one enzyme that is capable of exhibiting detergent activity, in that the preparation is performed on-site with the treatment device and in that the amounts supplied of the at least one detergent formulation and of the at least one enzyme concentrate as part of the at least one detergent formulation are determined in weight.

In another embodiment, the present invention provides the use of the apparatus according to the present invention for the preparation of at least one enzyme-containing detergent formulation by mixing the ingredients of the formulation and for supplying the at least one detergent formulation to at least one treatment device.

The applicants have found that the present invention brings a number of significant advantages, in particular in an industrial and/or institutional framework where washing and cleaning operations are of a larger scale and more intense than in a consumer household, and where the priorities and sensitivities are also very different.

An important benefit of the present invention is an improvement in the safety and industrial hygiene on the site where the treatment device is located, but at the same time also on the location remote therefrom where in the conventional supply chain the detergent formulation used to be prepared and packaged.

The applicants have found that the apparatus according to the present invention is very suitable for being installed in an industrial and/or institutional environment on-site with the point or points of application of the detergent formulation that it is intended to produce. In a preferred embodiment, the discharging device or devices of the apparatus are in fluid communication with the treatment device or the treatment devices to which the detergent formulation should be supplied.

The applicants have found that a hardware fluid connection between the apparatus according to the present invention and the treatment device, or for supplying the detergent formulation to the at least one treatment device as part of the method according to the present invention, by fixed or flexible piping allowing the transfer of liquids, avoids the need for personnel to handle enzyme-containing products, such as enzyme concentrates or an enzyme-containing additive as a process intermediate, and thus avoids the possible exposure of personnel to such products, including aerosols thereof. The applicants have therefore found that the apparatus and the method according to the present invention bring a significant improvement in terms of industrial hygiene for the work environment where the washing or cleaning services are provided. Because the detergent formulation is prepared on the site of the consumer, and not anymore on the site of the supplier, i.e. remote from the location of treatment, also the safety and industrial hygiene at the site of the supplier of the detergent formulation is improved.

The present invention is directed to the preparation of an enzyme-containing detergent formulation on-site with the operations that use the formulation, preferably using the apparatus that is connected via the discharge device to the treatment device using the formulation. There is thus during operation no possible contact and also no contact needed, of humans with any of the products starting from the preferable plurality of packages of the enzyme concentrates that are brought on-site, connected as a feed source to the apparatus via the feed device and preferably placed inside the housing of the apparatus such that they are made inaccessible inside an enclosure and behind locked doors, and up to the point where the detergent formulation is injected into the treatment device.

With the apparatus according to the present invention, and with the method according to the present invention, the need for any human intervention during operation may be avoided. This setup brings the advantage that the risk for humans being exposed to aerosols of the enzyme-containing detergent formulation or to any of its enzyme-containing constituents is strongly reduced and possibly even avoided.

The exposure risk may further be minimized by providing a washing step of the apparatus according to the present invention or of the equipment used in the method according to the present invention before the equipment is released for a human intervention.

The supply of the detergent formulation on a weight basis brings the advantage of a highly accurate supply of the amount of enzyme concentrate that is requested and this over a very wide range of dosing amounts. The applicants have found that the present invention allows the delivery of the requested enzyme concentrates with an accuracy of ±1% and this over a range that includes a dosing as low as 0.02 grams per kilogram of linen but also includes a dosing as high as 1.4 grams per kilogram of linen. The applicants have surprisingly found that the present invention is thus able to deliver a high dosing accuracy over a dosing range that covers almost two orders of magnitude.

A further advantage of the present invention is that the recipe of the detergent formulation that should be delivered to the treatment device may be tailor made and tuned finely to the requirements and desires of the client. The on-site preparation of the detergent formulation brings the possibility to adjust the individual dosing of the different enzyme concentrates and this independent of the dosing of any surfactant that may be part of the same detergent formulation. The close proximity in time and location between the preparation and the application of the detergent formulation allows to use the dosing of each individual one of the available enzyme concentrates as independent parameters in optimizing the cost and the performance of each one of the treatment device supplied by the apparatus and by the method according to the present invention. This dosing flexibility is not available in the conventional setting wherein the detergent formulation needs to be prepared off-site and transported to the site of consumption.

The presence of the level sensor on the discharge vessel brings the benefit that from each one of the at least one discharge vessels accurately multiple amounts of the detergent formulation contained therein may be supplied on a weight basis to the at least one point of use. The apparatus allows to supply the detergent formulations that are prepared to multiple treatment devices, which may be the same or different, and which may in addition have differing needs depending on the services rendered. The apparatus allows to accurately keep track on a weight basis of how much of the specific detergent formulation stored in any one of the discharge vessels has been distributed to the treatment devices in between two successive low level alarm signals triggered by the level sensor on the particular discharge vessel, as well as how much of any particular enzyme concentrate this formulation contained. This brings the advantage that the accuracy obtained during the creation of the composition by weight of the detergent formulation, which is provided by the weighing cell on the mixing vessel, also directly applies to the amounts that are transferred to the possibly multiple treatment devices from the discharge vessel. This allows for an accurate dosing, on a weight basis, of the detergent formulation and of the enzyme concentrates employed therein, from each discharge vessel towards every one of the multiple treatment devices it may be connected to. It allows in particular an accurate supply of one or more of the enzyme concentrates, on a weight basis and over a wide range of amounts that may be requested for treatments of different severities. It further enables an accurate accounting on a weight basis of the consumed amounts of detergent formulation as well as of the precious enzyme concentrates contained therein. The difference of the present invention with D1 also allows for corrections in the dosing if a deviation from intended values has been observed, enabling a recalibration that may even be made automatically without requiring any human intervention. This reduces the risk for underdosing as well as for overdosing, and therefore assures an optimal effectiveness and an optimal efficiency of the active ingredients in the detergent formulations, in particular the more precious enzyme concentrates.

A further advantage of the present invention is that the close proximity in time and location between the preparation and the application of the detergent formulation, allows to further fine tune the recipe of the detergent formulation, taking into account parameters, such as viscosity and density, which parameters may be depending on local environment conditions. Dosing of each individual one of the available enzyme concentrations may thus be adjusted taking into account such parameters, resulting in an increased dosing accuracy. A further advantage of the present invention is that any variations that may be noticed in the transfer of detergent formulation towards the treatment devices may be fed back to the operation of the mixing vessel and be used to bring corrections in the creation of the subsequent batch of that same detergent formulation. This feedback may be arranged automatically, which brings the advantage that the dosing of the detergent formulations made in the mixing vessel may be subject to an autocalibration system that keeps each one of the doses as close as possible to the intended value. This advantage strongly reduces the risk for underdosing or overdosing, which brings the advantages of keeping a high level of effectiveness as well as efficiency in terms of the use of the enzyme concentrates and/or of the surfactants.

The close proximity in time and location between the preparation of the formulation and the use thereof, and the dedicated connection between the preparation apparatus and the treatment devices also allows almost immediate feedback on the performance of the formulation, and hence allows a ready adjustment of the formulation to the substances for which the formulation is designed.

Enzymes are introduced into washing and cleaning operations because of their high effectiveness. Only small amounts of the enzyme concentrates are required to deliver the same performance as much higher amounts of surfactants when only surfactants are used. The presence of the correct enzymes in the formulation thus allows to significantly reduce the amounts of surfactants that may still be needed in the washing or cleaning operations. The reduction in surfactant need reduces the costs of the detergent formulation, and because the surfactants end up in the waste water where the reduction in surfactant use contributes significantly to the reduction of the biochemical oxygen demand (BOD) and/or COD, and hence to the environmental tax that is levied by the authorities in return for a license to discard that water.

An important feature of the present invention is that the detergent formulation is prepared on-site and in batch quantities that may be kept small such that they do not need to be stored long before consumption in the treatment device.

This brings the yet further advantage that the enzyme-containing detergent formulation may be prepared with little of any enzyme stabilizing system, preferably even without any. In the first place, those enzyme stabilisers or stabilizing systems are expensive ingredients for a detergent formulation. Secondly, some stabiliser systems may still have some inactivating effect on the enzymes in the formulation, even at the diluted concentrations in a washing liquor, and thus require the formulation to contain somewhat more of the target enzyme concentrates. And enzyme concentrates are by far the most expensive ingredient of a detergent formulation. Thirdly, the stabilisers in the detergent formulation finally end up in the waste water from the washing or cleaning operations that uses the formulation, where they increase the BOD and/or COD of the waste water, and hence also increase the taxes that governments demand for allowing the disposal of that waste water. The reduction and preferably the avoidance of any enzyme stabilizing system therefore contributes further to a reduction in the BOD and/or COD in the waste water from the treatment device, and hence to the environmental tax demanded in return for a license to discard that water.

In an embodiment of the present invention, the apparatus may contain several discharge vessels, which may each contain a different detergent formulation or which may each be dedicated to contain a specific type of detergent formulation. Advantageously, the apparatus may then have different detergent formulations, which are immediately available for a user to select. A further advantage is that a rinsing step in between transferring a new batch of the same detergent formulation to a dedicated discharge vessel, may be omitted.

In a preferred embodiment, the apparatus according to the present invention remains the property and under full control of the supplier of the detergent formulation, while the treatment devices receiving and consuming the detergent formulation are owned and controlled by the provider of the washing or cleaning services, the two forming different parties and usually also being different legal and economic entities.

EP 2857491 A1 is concerned with the problem that the concentration of a peroxy acetic acid (a.k.a. peracetic acid or PAA) in a bleach and/or disinfectant formulation, once it has been prepared, decreases over time as a result of decomposition to acetic acid. The document describes an apparatus for the on-site preparation of peracetic acid. The final concentration of the product formed in the reactor of the apparatus depends on a high number of parameters: the reactants used, the duration of the reaction and the reaction conditions in general, such as the metal ions present in the solvent used, the temperature during the reaction and the amounts of reactants used during the forming of the bleach and/or disinfectant. The apparatus is equipped with a detection element which detects chemical activity in the reactor, on the basis of which the controllable flowmeter controlling the discharge of the product to the treatment device is controlled. The quantity of product discharged to the treatment device is then controlled by measuring the discharged volume or by measuring the discharge time. The customer of the bleach and/or disinfectant is with the apparatus at least guaranteed that he is each time supplied a volume of PAA product that was freshly prepared and hence should show optimum activity and performance relative to the same product prepared off-site and stored/transported before being supplied to his treatment device.

EP 3321751 A1 relates to a chemical dispensing system and is concerned with increased control of product use and a reduction of human contact with potentially hazardous chemicals. The document discloses a wireless interface module for a chemical dispensing system operating in association with one or more washing machines. The document is silent about the kind of the chemicals dispensed, and about the nature of the ingredients therein. The addition of the chemicals is controlled via a control on the pumps in a pump stand, and hence operates on a volumetric basis. The raw material containers may be provided with probes indicative of the level of product in the container, which is also on a volumetric basis.

US 2017/0223921 A1 discloses an on-site chemical blending and dispensing system for providing teat dip mixtures in the context of cattle milking operations. The flow control devices used may be peristaltic pumps and hence operate on a volumetric basis. The document gives no further details about the mixing chamber itself in which the teat dip mixtures are prepared.

WO 2006/000237 A1 relates to a method for multiple dosage of one or more liquid products, such as ingredients used in processes for washing textiles, as well as to a dosing apparatus and a dosing system. The dosing amount of a liquid product is measured by a weight cell in each dosing cycle and can be transferred to an application device where it is instantly consumed or into an intermediate storing vessel. The document gives no further details about how the transferred products, which may also be temporarily stored, are dosed towards an application device. Each transfer or dose of a particular liquid product requires one or more operating cycle in the apparatus.

JP H10 142035 A discloses a method for accurately metering the supply of raw materials. Detergent raw materials are introduced from respective raw material tanks to a mixing tank, thereby controlling the amount of raw material that is supplied. The amount of raw materials is controlled by use of transfer pumps, control valves and intermediate storage chambers measuring the amount of raw material. The document gives no further details on how the resulting detergent slurry is accurately dosed downstream from a buffer tank to an application.

The preparation, in the context of the present invention, of the enzyme-containing detergent formulation on-site of the treatment device, brings the advantage that the detergent formulation is consumed shortly after its preparation. There is thus less need for an enzyme stabilizer system in the formulation, and often the use of an enzyme stabilizer system in the formulation may be omitted. The geographical proximity of the apparatus preparing the formulation with the device using the formulation allows for a very small intermediate storage of the formulation between preparation and use, and hence for very short residence times in that storage. This strongly reduces the risk for deposit formation or other disturbing results of a possible incompatibility between different ingredients in the same formulation, such that only very low levels of enzyme stabilizing systems should be incorporated, preferably none being required. The formulator and supplier of the detergent formulation may thus enjoy the benefit of a reduced cost of his formulation. The consumer of the formulation and the supplier of the formulation may thus collectively enjoy the advantage that the enzymes may exhibit their activity as part of the washing and/or cleaning operation with a reduced and preferably without any impairment caused by the presence of an enzyme stabilising system. Another advantage is the reduction and preferably the avoidance of the extra environmental burden that the usual enzyme stabilizing systems are causing. The provider of the washing and/or cleaning service using the formulation may therefore also enjoy the further direct benefit of reducing and preferably avoiding the extra taxes that are typically imposed because of the higher COD in his waste water or for any other extra environmental burden that is caused by the enzyme stabilising system.

The proximity of the preparation with the consumption of the detergent formulation, and the short residence times of any intermediate storage, also allows for small preparation batches, and for the preparation each time of a tailor-made formulation. This allows for a very quick feedback on the performance of a formulation after its preparation, and thus allows for further adjustments of the preparation recipe during subsequent preparation cycles of the same formulation. The formulation may thus be fully adapted to the intended use and the recipe may be adjusted based on the quick performance feedback. The types of enzymes in the formulation may be selected accordingly, as well as their respective dosing. Also the type and level of any of the surfactants in the formulation may be tuned to the intended use. The apparatus and method according to the present invention therefore allow a close tailoring of the detergent formulation, as much as practically possible, to the service in which the formulation is intended to be used. The apparatus and method therefore allow to avoid the inclusion in the formulation of enzymes that are not required, as well as avoiding any over- or underdosing of the enzymes relative to the performance which they are expected to deliver. The apparatus and method according to the present invention therefore allow to reach an improved balance between the desires for effectiveness and efficiency of the enzyme-containing detergent formulation discussed before in this document.

The owner of the apparatus and provider of detergent formulation may thus convincingly assure the provider of the washing and/or cleaning service that on the one hand the detergent formulations that the apparatus is supplying are bringing the expected effectiveness for the service they are intended for, while on the other hand also that they are as cost efficient as practically possible.

The enzyme concentrates are commercially available on a weight basis. The applicants have found, because the apparatus produces its batches of detergent formulations on a weight basis, and also adds the enzyme concentrates into the batch on a weight basis, that also the detergent formulations supplied to the treatment devices may be accounted for on a weight basis, and that the amounts of enzyme concentrates that are delivered to the treatment devices may be accounted for on a weight basis. The provider of the detergent formulations may thus charge his supplies to the treatment devices of his customer on a weight basis and therefore in an open and transparent way. Not only is the customer assured of the effectiveness of the supplies of detergent formulation from the apparatus and with the method according to the present invention, he may also convincingly be assured that he will only be charged for the enzyme concentrates that actually have been supplied to his treatment devices.

### BRIEF DESCRIPTION OF THE DRAWINGS

FIG. 1 shows a schematic view of an embodiment of the apparatus according to the present invention and of one embodiment about how that apparatus may be connected to the treatment devices to which the apparatus supplies detergent formulations after their preparation.

FIG. 2 shows a schematic view of how the apparatus of FIG. 1 may be connected electronically and preferably virtually with a server and how information may flow back and forth between the apparatus and the server.

FIG. 3 shows the results of the activity of washing liquors containing all the same concentration of the same lipase enzyme concentrate for the total hydrolysis of rapeseed oil in the absence and in the presence of one particular surfactant that was selected from a wide range of different surfactants.

### DETAILED DESCRIPTION

The present invention will hereinafter be described in particular embodiments, and with possible reference to particular drawings. The invention is however not limited thereto, it is only limited by the claims. Any drawings described are only schematic and are non-limiting. In the drawings, the size of some of the elements may be exaggerated and not drawn to scale for illustrative purposes. The dimensions and the relative dimensions in the drawings do not necessarily correspond to actual reductions to practice of the invention.

Several documents may be cited throughout the text of this specification. However, there is no admission that any document cited is indeed prior art of the present invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than those described and/or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein may operate in other orientations than described or illustrated herein.

The verb “to comprise”, as used in the claims in its various grammatical forms, should not be considered as being limited to the elements that are listed in context with it. It does not exclude that there are other elements or steps. It should be considered as the presence provided of these features, integers, steps or components as required, but does not preclude the presence or addition of one or more other features, integers, steps or components, or groups thereof. Thus, the volume of “an article comprising means A and B” may not be limited to an object which is composed solely of agents A and B. It means that A and B are the only elements of interest to the subject matter in connection with the present invention. In accordance with this, the terms “comprise” or “embed” enclose also the more restrictive terms “consisting essentially of” and “consist of”. By replacing “comprise” or “include” with “consist of” these terms therefore represent the basis of preferred but narrowed embodiments, which are also provided as part of the content of this document with regard to the present invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding the understanding of one or more of the various inventive aspects. This method of disclosure, however, is not to be interpreted as reflecting an intention that the claimed invention requires more features than are expressly recited in each claim. Rather, as the claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art.

In the description provided herein, numerous specific details are set forth. However, it is understood that embodiments of the invention may be practiced without these specific details. In other instances, well-known methods, structures and techniques have not been shown in detail in order not to obscure an understanding of this description.

Unless specified otherwise, all ranges provided herein include up to and including the endpoints given, and the values of the constituents or components of the compositions are expressed in weight percent or % by weight of each ingredient in the composition.

As used herein, “weight percent,” “wt-%,” “percent by weight,” “% by weight,”, “ppmwt”, “ppm by weight”, “weight ppm” or “ppm” and variations thereof refer to the concentration of a substance as the weight of that substance divided by the total weight of the composition and multiplied by 100 or 1000000 as appropriate, unless specified differently. It is understood that, as used here, “percent,” “%,” are intended to be synonymous with “weight percent,” “wt-%,” etc., unless otherwise specified.

It should be noted that, as used in this specification and the appended claims, the singular forms “a,” “an,” and “the” include plural referents unless the content clearly dictates otherwise. Thus, for example, reference to a composition containing “a compound” includes a composition having two or more compounds. It should also be noted that the term “or” is generally employed in its sense including “and/or” unless the content clearly dictates otherwise.

Additionally, each compound used herein may be discussed interchangeably with respect to its chemical formula, chemical name, abbreviation, etc..

In the context of the present invention, with a liquor for washing or cleaning is meant a composition for use as the agent in a washing or cleaning bath. A “washing or cleaning bath” is understood as that functional solution containing the agent for washing or cleaning that acts on textiles or fabric (washing bath) or hard surfaces (cleaning bath), and which comes in contact with the stains present on textiles or fabrics, or present on hard surfaces. The washing or cleaning bath is usually created when the washing or cleaning operation begins and the washing or cleaning agent is dissolved in or diluted with water, for example in a washing machine or in another suitable vessel.

The enzymes for use in washing processes are made commercially available as concentrates of particular individual enzymes and/or of a mixture of a low number of particular enzymes. The concentration of the enzyme itself in the offered concentrate is proprietary information of the concentrate supplier. The concentrate further typically contains at least one stabiliser such as ethylene glycol or other glycols or polyols. Due to these stabilisers, the enzymes in the concentrate are not active, kind of “dormant”, but stable. It is only when the concentrate is significantly diluted, such as when the concentrate is added into the washing process, that the inhibition effect by the stabiliser strongly reduces and possibly even disappears, and that the enzyme becomes active and possibly gain its full activity.

As a result of this confidentiality on the actual enzyme concentration in the commercially available enzyme concentrates, the industry has adopted a practice to express the enzyme levels in terms of how much of the particular enzyme concentrate that has been added into the formulation. This document applies that same practice.

Enzymes are for 100% composed of proteins. In liquid enzyme concentrates, typically all of the proteins present are enzymes, but there is never an unambiguous assurance that all the proteins in the enzyme concentrates are necessarily present as enzymes, let alone as active enzymes. An upper limit on the total protein concentration of a composition therefore provides an upper limit on the total enzyme presence in that composition. The total protein content of an enzyme containing product, including an enzyme concentrate but also any detergent formulation containing an enzyme concentrate, may readily be determined by means of the so-called bicinchoninic acid assay (in short “BCA assay”), also known as the “Smith assay” and well-known in the art. The protein concentration in a commercially available enzyme concentrate is therefore publicly available information, and cannot be claimed as being information proprietary to the supplier. The typical protein levels in commercial enzyme concentrates are in the range of 5-10% wt. Enzyme concentrates having higher total protein concentrations are very rare to non-existent commercially in the industry. Technical limitations or commercial reasons may explain the absence thereof.

The actual concentration of a particular active enzyme in a commercial enzyme concentrate product is by most producers treated as confidential information proprietary to the supplier. In order to enable the client to obtain particular product labels however, this information may need to be supplied to the issuing authorities. The customer using the concentrate may thus be informed in a more detailed manner about the composition of the enzyme concentrates that he obtains from the supplier, but he is not at liberty to disclose that information to the public.

The alkyl polyglycoside surfactant is the result of an etherification of a (fatty) alcohol with at least one alcohol function of the sugar-based hydrophilic part of the compound. During the etherification step the other available alcohol groups on the glucose part also engage into etherification reactions, thereby forming a “polymeric” compound, which is why the final product is called a “polyglycoside”. The compound is typically a derivative of fat for the alcohol and lipophilic part, and of starch for the hydrophilic part of the compound. When the sugar-based starting material is essentially only glucose, the compound is named an alkyl polyglucoside.

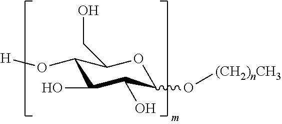

Molecular structure of alkyl polyglucoside, wherein m=the degree of polymerisation.

The concentration of the enzyme concentrates in the detergent formulation may be very broad. In the ultimate washing liquor, the activity of a particular enzyme concentrate ingredient may already be observed at a level of 1 ppm by weight. The inventors prefer to typically use a concentration of up to about 250 ppm by weight per enzyme concentrate in the washing liquor. The inventors further prefer to adjust the enzyme cocktail in the additive formulation and in the washing liquor to the amount and types of soil that are expected in the substrate to be treated.

The amine oxide is preferably the oxide of a tertiary amine (R₃N⁺—O⁻), more preferably an alkyl dimethyl amine oxide, even more preferably lauryl dimethyl amine oxide (CAS 1643-20-5). Although this amine oxide is known as a high foaming surfactant, the inventors have found that the foaming may be kept acceptable by correct dosing of the amine oxide depending on the type and amounts of soil on the substrate. High soil levels, especially particulate soil types, may also suppress the foaming of a washing liquor.

In an embodiment of the present invention, the at least one mixing vessel is equipped for forming the batch of the detergent formulation according to a predetermined recipe expressed by weight. The apparatus may for instance be provided with a control device or controller, typically a programmable logic controller or “PLC”. Such a controller may guide the feed devices in supplying amounts from their respective feed sources into the mixing vessel in accordance with a predetermined recipe. This recipe for the preparation may for instance be stored in the memory of the control device. The recipe may for instance be entered manually by means of a keyboard connected by wire or wireless to the control device, possibly assisted by means of a monitor or screen. Alternatively or in addition, such a recipe may be introduced remotely by an electronic connection, wired or wireless, between the control device of the apparatus and a server. This server may possibly be located remotely, e.g. on a site owned by the supplier of the detergent formulation and the connection may be over the internet. The same variety of methods may also be used for adjusting or correcting a recipe that is already stored in an electronic memory as part of the controller or the apparatus, or connected thereto.

In an embodiment of the present invention, the at least one mixing vessel is equipped with a weighing cell or balance that is capable of monitoring and signalling the gross weight of the at least one mixing vessel, i.e. including its content. The applicants have found that a suitable mixing vessel and associated weighing cell may be provided such that even small amounts by weight of an ingredient that was actually added into the mixing vessel may be determined with high accuracy. The apparatus may be provided such that it is able to also control the introduction of the ingredients into the mixing vessel with high accuracy, preferably the introduction of the enzyme concentrates. The applicants have for instance found that the mixing vessel may be made of lightweight material. The applicants have also found that any mixing mechanism for the mixing vessel may be provided without that this mechanism contributes to the gross weight of the mixing vessel. The applicants have found that this arrangement and equipment is highly suitable for achieving a high accuracy in the supply of the amount of detergent formulation, and in particular also of the amount of an enzyme concentrate and of the other ingredients that are part of it, and this over a very wide range of dosing amounts, in particular of the enzyme concentrate. The applicants have found that a control unit associated with the method and/or apparatus according to the present invention may readily keep track of the amounts by weight of the individual ingredients that are added into the mixing vessel as part of the preparation, and hence is able to derive from that information the recipe according to which the batch of the detergent formulation was actually prepared. This allows for a high accuracy in the preparation of the detergent formulation and also for a ready comparison of the actually formed detergent formulation and the recipe according to which it was expected to be prepared, and this on a weight basis. It also allows for a highly reliable accountability of each and every ingredient of the detergent formulation that is supplied to the treatment device, in particular of any enzyme concentrate that has been used in the preparation of the detergent formulation that is supplied to the treatment device. A suitable weighing cell or balance may for instance be selected from the wide range of capacities that are offered under the label Single Point Aluminum Load Cell Model 1022 available from the company Vishay Precision Group (VPG, Malvern, PA 19355, USA).

The applicants have found that the use of a weighing cell for monitoring the weight of the mixing vessel and its content is able to provide a high accuracy in the preparation of the detergent formulation, in particular when enzyme concentrates are used as ingredients.

The feed sources, including any enzyme concentrates, are typically all liquids. Ingredients other than tap water may thus be provided in transportable containers which may manually be connected with the corresponding feed device. The applicants have found that the feeding of the ingredients from the plurality of feed sources to the mixing vessel may readily be arranged by providing as feed device for each feed source a pump that is connected on the suction side to the feed source and which is pumping the ingredient via piping into the mixing vessel. The pump is preferably a positive displacement pump. This type of pump is usually self-priming, which allows the pump to be located above the feed source, more importantly allows the feed source to be stored below the pump, e.g. underneath the apparatus as part of the same housing. The supply of the particular ingredient may then be controlled by controlling the time that the particular pump for that ingredient is activated, or alternatively the pump may be activated until the desired weight increase for the particular ingredient is measured by the weighing cell. The latter method brings the advantage that the amount of ingredient added is not affected by any time needed for pump priming of by the pump pushing air instead of the liquid ingredient. The applicants prefer to use a membrane pump. For obtaining the high accuracy in the preparation of the formulation, the applicants prefer not to rely on the pumping time for determining the amount of ingredient that was added, but they prefer to depend on the weight signal issued by the weighing cell and monitor the weight that has been gained from before till after the transfer of the particular ingredient.

An alternative to the pumping arrangement for transferring ingredient from a feed source to the mixing vessel would be to store the feed source above the mixing vessel and allowing the liquid from the feed source to flow into the mixing vessel by gravity, preferably controlled by a valve provided in the piping between the feed source and the mixing vessel. In this arrangement, the connection from the container as feed source to the piping should be non-leaking because that connection is subject to the static head of the liquid in the container.

The applicants prefer the alternative with the pump, at least for the liquid ingredients other than water. The connection to the feed pump may then be as simple as a flexible tube that is entered from above in the container with the liquid ingredient, and preferably its inlet is brought down to as close as possible to the bottom of the container, preferably even in a bottom pit provided as part of the container bottom.

Water may preferably be supplied to the mixing vessel by means of a connection of the apparatus to a water supply under pressure, such as a tap water supply, and for which the flow may be controlled by controlling the opening of a valve provided in the piping to the mixing vessel.

Preferably the mixing vessel is on top open to the atmosphere, such that any vapour or gas coming in with the transfer of a liquid ingredient may readily escape and does not lead to any pressure building up in the mixing vessel, which could possibly impair an accurate measurement by the weighing cell. Such vapour in the liquid supply may for instance be occurring after a replacement of a container for a particular ingredient, or during the self-priming of a pump.

Preferably the piping coming from the pump for pumping the feed source is not physically connected to the wall of the mixing vessel, but is hanging above and preferably a small distance inside the top section of the mixing vessel. This avoids that the piping could possibly affect the reading of the weight of the mixing vessel by the weighing cell, e.g. by weighing on the vessel wall.

In an embodiment of the present invention, the mixing vessel in the apparatus is provided with a stirring mechanism suitable for homogenizing the detergent formulation such that the detergent formulation comprises the at least one enzyme concentrate in a predetermined concentration. The stirring mechanism should assure that the amount of enzyme concentrate that is introduced into the mixing vessel is evenly distributed over the amount of detergent formulation that is prepared in the mixing vessel. This brings the advantage that every supply of the formulation to the treatment device brings along the appropriate amount of the enzyme concentrate, and hence the appropriate amount of the enzyme that is selected and desired for being delivered with the detergent formulation to the treatment device. As already stated above, the stirring mechanism is preferably provided in such a way that the stirrer and its driver are physically free from the mixing vessel itself and that they do not contribute to the gross weight of the mixing vessel that is monitored by the weighing cell. A suitable stirrer may for instance be a turbine that becomes submerged in the liquid content of the mixing vessel, on an axis that is driven by a motor provided above the mixing vessel.

In an embodiment of the present invention, the apparatus is for the on-site preparation and supply of at least two enzyme-containing detergent formulations, the apparatus for that purpose comprising at least two discharge vessels each one being connected to its own dedicated discharge device. This brings the advantage that the apparatus is capable of preparing and supplying at least two enzyme containing detergent formulations that are different from each other. A first formulation may for instance be designed for washing lightly soiled textiles while a second formulation may be designed for washing heavily soiled textiles. Textiles with intermediate degrees of soiling may then be washed by a mixture of the first and of the second formulation, and the relative ratio of the two formulations in the mixture may each time be adapted for being the perfect match for a wide range of intermediate soiling degrees, or laundry classifications. This versatility may be further enhanced by preparing three different detergent formulations: a first one for lightly soiled textiles, a second one for textiles heavily soiled with one particular type of stains, and a third one for textiles heavily soiled with another particular type of stains. The availability of at least two different enzyme-containing detergent formulations thus strongly enhances the capability of the apparatus to match the supply of enzymes very closely to the type of soiled textiles that need to be washed in one or more treatment devices. This capability strongly enhances one of the most important technical effects offered by the present invention, i.e. that the treatment devices supplied by the apparatus are each time supplied with the correct type of enzyme concentrates in a concentration that is correct for the treatment step that it is going to be performing. This capability strongly enhances the advantage brought by the present invention that the choice and dosing of the enzymes become additional and independent parameters in the treatment process downstream of the apparatus. This also brings the advantage that the enzyme concentrates are only used when needed, and in only the concentrations that are needed. This capability thus also enhances the effectiveness and the efficiency of the enzymes used in the treatment process.

In an embodiment of the present invention, the apparatus is comprising a plurality of discharge vessels and wherein the connection between the at least one mixing vessel and the plurality of discharge vessels is equipped with a selecting device capable of establishing a one-on-one relation between the outlet of the at least one mixing vessel and the inlet of one element selected from the plurality of discharge vessels. This brings the advantage that the apparatus may be used to prepare and distribute more than one batch of detergent formulations, that these detergent formulations may differ from each other. These different detergent formulations may be targeting different washing and/or cleaning applications via different discharge vessels. These different detergent formulations may also be used in combination with each other, e.g. in different mixture ratios, in order to provide the more appropriate cocktail of ingredients to each one of two or more different applications. Different applications may for instance be different steps as part of the same washing and/or cleaning operation, such as a pre-wash and a main wash, whereby the pre-wash may for instance precede the main wash either in time in the same batch treatment device or in place in the same continuous treatment device. Or the different applications may be similar or different washing and/or cleaning steps performed by two different treatment devices, or by the same treatment device at different times, whereby the objects that are treated may have a different classification. This feature thus brings the advantage that the apparatus according to the present invention may serve simultaneously two or more different treatment steps or two or more different treatment devices. The applicants have found that the apparatus according to the present invention is preferably provided with two, more preferably with at least three and even more preferably at least four discharge vessels.

The one-on-one relation brings the advantage of a low risk for cross-contamination between two different batches of detergent formulations, e.g. two batches that were prepared by two subsequent preparation cycles of the apparatus.

The applicants have found that in an embodiment of the present invention a suitable selecting device for establishing the one-on-one relation may be provided by arranging a carousel of a number of discharge vessels below the outlet of the mixing vessel including its associated weighing cell and a valve that is closing off the outlet of the mixing vessel. The mixing vessel outlet may be fixed in a position above the carousel but eccentric to the carousel axis. Each one of the discharge vessels may then be brought underneath the mixing vessel outlet alternatively, e.g. by turning the carousel around a vertical axis until the correct discharge vessel is in position underneath the mixing vessel outlet. When the preparation of the detergent formulation is completed, when the weight of the mixing vessel content may be registered and when the preparation may have been verified to have happened according to the prescribed recipe, the valve in the mixing vessel outlet may be opened and the mixing vessel content may be emptied into the selected discharge vessel that is located underneath the mixing vessel outlet. Preferably the mixing vessel is located higher than the discharge vessel, and the emptying of the formulation from the mixing vessel into the discharge vessel may occur by draining by gravity. From the difference in weight, as registered by the weighing cell, of the mixing vessel before and after the discharge of the mixing vessel content, the control unit may derive the amount by weight of detergent formulation that was added into the particular discharge vessel that had been positioned underneath the mixing vessel outlet and which may be useful for a correct dosing. The carousel may then turn and bring another discharge vessel underneath the mixing vessel outlet, ready for accepting the next batch of detergent formulation that may be prepared in the mixing vessel subsequently. In this setup it is the carousel which is acting as the selecting device of this embodiment. The discharge vessels may also be open on top to the atmosphere. The opening in the valve that controls the emptying of the mixing vessel may be limited such that the risk for splashing of the mixing level content when this is arriving in the discharge vessel is minimized.

In an embodiment of the present invention wherein the apparatus is comprising the selecting device, the selecting device is further capable of establishing a one-on-one relation between the outlet of the at least one mixing vessel and the inlet of a waste disposal provision. This provision brings the advantage, if an unacceptable deviation has been observed between the actual preparation procedure and the prescribed recipe, that the mixing vessel content may be rejected as waste and be discarded into the waste disposal provision. The mixing vessel is then again ready for the preparation of a new batch. This provision also brings the advantage that the apparatus may perform a wash step in which the mixing vessel is washed with a solvent or with water in between two successive batch preparations, and the spent solvent or wash water may be kept from entering one of the discharge vessels. In the above embodiment with the carousel, one of the carousel positions that may be brought underneath the outlet of the mixing vessel may be the inlet of the waste disposal provision.

The waste disposal provision may comprise a collection pot into which all drainage of liquids from the various locations in the apparatus may collect, including any splashed or leaked liquids. Such a collection pot may be provided with a high level signal and alarm. Such a level signal may also trigger an activation of a waste disposal pump for pumping the waste liquid from the collection pot into an appropriate waste disposal facility of the site where the apparatus is located.

In an embodiment of the present invention, the at least one discharging device comprises a flow control means. This flow control means may be used for controlling the administration or dosing of the detergent formulation to the at least one treatment device. This flow control means may preferably offer the functionality of a controllable flowmeter, and this functionality may for instance be brought by a positive displacement pump of which the flow rate is fixed and the control is offered by controlling the time during which the pump is pumping, as explained further below. This flow control means is preferably instructed, for instance via the apparatus controller, by a dosing system, to deliver a set amount of the detergent formulation from the discharge vessel to one treatment device selected from the at least one treatment device to which the discharging vessel is connected.

In an embodiment of the present invention, the at least one discharging device should be capable of supplying its formulation to a plurality of treatment devices. In that embodiment, the discharging device comprises a selection device for establishing a one-on-one relation or connection to one treatment device selected from that plurality. Such selection device may for instance have the form of a piping distribution manifold and control valves on the outlets of the manifolds towards the individual treatment devices, of which one of the outlet valves may be set open while the other outlet valves are set closed.

In an embodiment of the present invention, the pump of the at least one discharging device for pumping the detergent formulation from the discharge vessel to the at least one treatment device is a positive displacement pump, preferably the pump being a membrane pump. The applicants have found that it is highly convenient to provide a pump as specified in claim 1 as part of the at least one discharging device, in order to perform the supply of the detergent formulation to the treatment device. A pump brings the advantage that a flow resistance in the piping connecting the discharge vessel to the at least one treatment device, and its associated pressure drop, may readily be overcome. A further advantage is that the supply of the detergent formulation from the discharge vessel may be controlled by controlling the activation of the pump. A positive displacement pump brings the additional advantage that the amount of detergent formulation supplied may be controlled by controlling the length of time during which the pump is activated, and that this amount is not affected by pressure changes downstream of the pump.

In an embodiment of the present invention, the supply connection between the at least one discharge device and the at least one treatment device is provided with a back-pressure regulator, preferably downstream of the pump that is provided as part of the discharge device. The obstruction formed by the back-pressure regulator brings the advantage that a pressure above atmospheric may be maintained upstream of the back-pressure regulator, and that this pressure remains independent of pressure changes downstream of the back-pressure regulator. The liquid in the discharge vessel is already able to provide a static head above atmospheric pressure. The pump provides an even higher pressure in the supply piping from the discharge vessel towards the at least one treatment device. The pressure above atmospheric brings the advantage that no air from the environment is able to leak into the supply connection. The pressure above atmospheric in the pump outlet also reduces the risk for the pump to cavitate. The applicants have found that the back-pressure controller brings the highly appreciated advantage that the pumping time becomes a highly accurate reflection of the amount of liquid that is supplied during that period of time from the discharge vessel to the at least one treatment device.

In an embodiment of the present invention, the supply connection from the at least one discharge device to the at least one treatment device is provided with a flow sensor, preferably downstream of the pump that is provided as part of the discharge device. The applicants prefer to have an additional sensor which is capable of indicating whether there is at a particular time a flow of liquid through the piping feeding product to a particular treatment device. This sensor is able to confirm or deny whether a particular dose of the formulation in the discharge vessel that is being pumped actually is directed to the treatment device for which it is intended. In case of mismatch, the sensor signal or the absence of any signal may be used to set an alarm and/or even to stop the supply that is ongoing but obviously flowing not towards the intended destination.

According to the present invention, the at least one discharge vessel is provided with a level sensor for at least detecting a low level in the discharge vessel. This allows the generation of a signal when the inventory of the detergent formulation that is stored in that particular discharge vessel is becoming low. Such a signal may be useful for a variety of purposes, such as putting out a warning about the approaching exhaustion of the product stored in that particular discharge vessel. The applicants prefer to set this level sensor at a level at which still a significant amount of inventory is present in the discharge vessel, preferably sufficient inventory for assuring several more dosing amounts, so that the supply from that discharge vessel may continue for longer than the time necessary for the apparatus to prepare a new batch of the same detergent formulation and discharging that batch into the discharge vessel for which the level sensor issued the low level signal. The applicants prefer to have the low level sensor at a level at which there is still sufficient inventory in the discharge vessel for continuing the predicted supply during at least 2 hours and in a laundry operation depending on the classifications of the textiles to be treated even up to a full day of further service.

In an embodiment of the apparatus according to the present invention, the low level signal of the level sensor is equipped for triggering the preparation in the at least one mixing vessel of a new batch of the detergent formulation and subsequently the transfer of that new batch into the at least one discharge vessel. This brings the advantage that the preparation of a new batch of the same or a similar formulation may be planned or triggered, such that this particular formulation remains available for the treatment device to which the discharge vessel is connected. The new batch may possibly even be produced following an adjustment of the formulation recipe based for instance on feedback gained about the performance of the previous batch supplied from this detergent formulation.

In an embodiment of the present invention, the at least one discharging device is equipped for supplying the detergent formulation by, upon demand, transferring to the treatment device from the detergent formulation during a period of time, preferably a period of time according to the amount of detergent formulation that is demanded. Preferably the controller of the apparatus receives as input a request for supplying a particular amount by weight of the particular detergent formulation in a particular discharge vessel towards a particular treatment device. The controller may in response to that request arrange for the one-on-one connection between the discharge vessel and the treatment device and activate the supply activity during a period of time that corresponds to the requested amount, using as the conversion factor a flow rate available in its memory for that supply particular arrangement. In absence of any later calculated flow rate, the controller may use a standard flow rate that was entered into the memory for that supply arrangement when the apparatus was constructed or when the arrangement was installed. If the supply is performed by means of activating a pump associated with the particular discharge vessel, the flow rate for that supply arrangement preferably corresponds to the flow rate of the pump and the standard flow rate may correspond to the nominal flow rate for that pump. If the pump is a positive displacement pump of which the stroke length is fixed, this type of pump brings the advantage of pumping a fixed volume of liquid with each pump cycle. The flow rate of the pump is thus directly proportional to the number of pump cycles performed over a particular time period. If the pump cycle frequency is also fixed, also the flow rate of the pump is fixed. In that case, the amount of detergent formulation transferred by the pump is directly proportional to the length of time during which the pump is activated. The applicants have found that the amount of detergent formulation supplied during a particular period of transfer, and hence the flow rate of the supply connection between the discharge vessel and the at least one treatment device, may readily be available in weight units per time unit. The controller of the apparatus knows the amount by weight of each batch of detergent formulation that has been prepared in the mixing vessel and which has been introduced from the mixing vessel into each discharge vessel. The controller also knows from the level sensor in the discharge vessels the time that it took to supply that same batch of formulation from that discharge vessel, i.e. the sum of all the transfer times during which liquid was drawn from that discharge vessel towards a treatment device in between two consecutive low level signals from the level sensor on that discharge vessel. For achieving high accuracy, the applicants prefer to split the periods of transfer during which the low level signal occurred and assign the time before the moment of the signal, and the associated volume, to the previous batch, while the time after the moment of the signal to the consecutive batch. From this data, the controller is able to derive a flow rate for the supply arrangement feeding from that particular discharge vessel when suppling that particular detergent formulation. The applicants have found that this flow rate may be determined fairly accurately, in particular in case the transfer is performed by a positive displacement pump.

In an embodiment of the present invention, the apparatus is equipped for registering the periods of transferring time of the detergent formulation to the treatment device and for reporting the supply of the detergent formulation to the treatment device on a weight basis. Most of this mechanism has already been explained above in this document. As explained above, the controller of the apparatus may know fairly accurately the flow rate by weight associated with a particular discharge device. Because it also registers the times during which the discharge device is activated towards a particular and selected treatment device, the controller of the apparatus is able to report the supply of the detergent formulation to the treatment device on a weight basis.

In an embodiment of the present invention, the apparatus is equipped for calculating the times of supply of the detergent formulation from the at least one discharge vessel to the at least one treatment device based on the total time of the supplies of at least one previous batch of the detergent formulation transferred to the at least one treatment device between two successive low level signals and the weight of that at least one previous batch of the detergent formulation that was prepared in the at least one mixing vessel. Preferably the actual flow rate for the supply arrangement associated with the discharge vessel may be calculated from the weight of the at least one previous batch of the detergent formulation transferred into that discharge vessel and the total time of the supplies of that batch of the detergent formulation transferred between two successive low level signals on that discharge vessel. Preferably the applicants prefer to use for the supplies of the subsequent batch the average of the flow rates for the last two batches, more preferably the last three batches, even more preferably the last four batches, and yet more preferably the last five batches. In case there have not yet been the number of desired last batches, the missing flow rates may in the calculation be replaced by the standard flow rate in memory for that particular supply arrangement. The applicants have found that this calculation provides a higher level of accuracy in the subsequent supplies from the discharge vessel to the selected treatment device, hence a higher reliability of the supplies, and therefore a closer approach to the desired optimum performance of the treatment device.

In an embodiment of the present invention, the apparatus is enclosed in an enclosure, preferably an enclosure that may be locked. This brings the advantage that any liquid splashes or any aerosol that may be formed during the operation of the apparatus may be contained inside the enclosure. This brings the advantage that contact of humans with such splashing or aerosol may be avoided. A further advantage, if the enclosure may be locked, is that the apparatus may physically remain under full control of who controls the access to the enclosure, e.g. the supplier of the detergent formulation.

In an embodiment of the present invention wherein the apparatus is enclosed in an enclosure, the enclosure comprises a ventilation system, preferably the exhaust of the ventilation system comprising a filter, preferably a filter capable of also capturing aerosols, more preferably including submicron liquid aerosols. The applicants have found that the ventilation system brings the advantage that the atmosphere inside the enclosure may be cleared from possibly harmful aerosols inside the enclosure as a result of the operations of the apparatus, for instance before the enclosure should be opened for allowing human access, such as for replacing a container of an ingredient, or for maintenance. In order for reducing the impact of the ventilation system of the apparatus and its enclosure on their environment, the applicants prefer to provide a filter on the exhaust system of the enclosure. More preferably the filter is capable of capturing aerosols, such that the risk for the enclosure to emit an aerosol of an enzyme containing liquid is minimized. Preferably the applicants provide a HEPA H14 class filter, according to industry standard EN 1822, according to which such a filter should retain 99.995% of the particles having the most penetrating particle size (“MPPS”).

In an embodiment of the present invention, a drip pan is provided underneath the discharge and mixing vessels. This drip pan is able to collect and contain any liquid drops that may originate from the operations in the apparatus. The drip pan is preferably provided with a bottom that is sloping towards a collection cup, which is provided with a level sensor and a pump for discharging any liquid collected in the collection cup towards a safe discharge facility. Preferably this drip pan is combined with the waste disposal provision and collection pot described above in this document.

In an embodiment of the present invention, the apparatus is configured for communicating via an external network. This exchange of information may for instance make use of the internet. The exchange may also be made possible via a wireless connection between the apparatus and a smartphone, tablet or personal computer of a person associated with the owner of the apparatus. The exchange, i.e. transmitting and/or receiving, of information is particularly advantageous for remote monitoring of the performance of the apparatus and for adjustment where necessary. The exchange may also offer possibilities for the accounting of the services delivered by the apparatus to the treatment devices. An external network preferably comprises an external server which is coupled by means of a wireless connection to the processing unit of the device. Such an exchange of information with an external network also provides the option of determining the remaining quantities of ingredients on the basis of the quantities of ingredients that have been consumed. In an embodiment of the present invention the apparatus is provided with a control panel where the user of the apparatus has the possibility of entering the recipes of the detergent formulations to be prepared and supplied. The remaining quantities of ingredients in the feed sources or containers may be calculated on the basis of these data. It is however also possible to provide the apparatus with measuring means which monitor the quantity of remaining ingredients in the feed containers.

In an embodiment of the process according to the present invention wherein the apparatus is provided with at least one water supply, and preferably the detergent formulation is water-based, preferably the water supply being a supply of city tap water and/or softened tap water. A tap water connection to the apparatus also brings the capability for providing rinsing steps as part of the method according to the present invention. The mixing vessel may for instance be washed with water in between the preparation of two batches of different formulations. After such a rinsing step, the mixing vessel may be emptied to the inlet of the waste disposal provision that may be foreseen. The discharge vessels may also each individually be provided with an outlet towards the waste disposal provision, so that also the discharge vessels may be cleaned by means of a water rinsing step. Emptying the apparatus and rinsing the different vessels may for instance be advisable when the apparatus should be prepared for being transported to another location or site. Some, most, or all of these rinsing steps are preferably for reasons of industrial hygiene executed without human intervention.

In an embodiment of the method according to the present invention, the weight of the mixing vessel including the content thereof is monitored during the transfer of the ingredients into the mixing vessel and the amounts in weight of each added ingredient is controlled and registered. Preferably the transfer of different ingredients is performed sequentially, such that the weight amount of ingredient added during a particular transfer is readily determined as, and preferably also controlled by, the gain in weight registered for the mixing vessel including its content between the first moment just before and the second moment just after the transfer. Preferably the transfer of ingredients into the mixing vessel is performed during periods of time during which none of the other pumps in the apparatus is activated, such as the pumps for the supply from the apparatus to a treatment device or the pump for discarding waste collected from the apparatus. This brings the advantage that the weight measurement of the mixing vessel is not possibly disturbed by any vibration caused by the running of a pump.

In an embodiment of the method according to the present invention, the method comprises the step of comparing the amounts in weight of all the added ingredients with a predetermined recipe for the detergent formulation. This step brings the advantage of verifying that the actually supplied detergent formulation is conform with the composition that was requested.

In an embodiment of the method according to the present invention including the step of comparing the weight amounts of all added ingredients with the predetermined recipe, if the prepared detergent formulation was deviating in an excessive degree from the predetermined recipe, the method further comprises the step of discharging the detergent formulation towards a waste outlet. In case an unallowable deviation from the recipe is registered, the method may include the step of discarding the mixing vessel content to a waste disposal capability provided to the apparatus.

In an embodiment of the method according to the present invention, the detergent formulation is discharged from the mixing vessel into at least one discharge vessel and the detergent formulation is supplied from the at least one discharge vessel to the at least one treatment device. The discharge vessel may be used as a so-called “day tank”, i.e. a temporary inventory of the detergent formulation from which the formulation may be supplied or “dosed” to consuming treatment devices while the mixing vessel is again made available for performing other steps of the method.

In an embodiment of the method according to the present invention, a plurality of discharge vessels is available for receiving the detergent formulation discharged from the mixing vessel and the method comprises, prior to the discharge from the mixing vessel, the step of establishing a one-on-one connection between the outlet of the mixing vessel and the inlet of one element selected from the plurality of discharge vessels and the waste disposal provision, if present. This brings the advantage that the risk for cross-contamination between different detergent formulations in the transfer from the mixing vessel and the discharge vessel or “day tank” is minimised. The provision of a rinsing step of the mixing vessel, in between the preparation of two consecutive batches having a different composition, may further reduce the risk for cross-contamination, in this case in the mixing vessel itself. Both measures contribute to the assurance that the detergent formulation that is supplied is indeed corresponding to what was requested and intended. Other measures, such as the verification of the composition with the recipe, also contribute to this same target.

In an embodiment of the method according to the present invention, the detergent formulation is supplied to the at least one treatment device by pumping the detergent formulation, preferably by a positive displacement pump, more preferably by a membrane pump. The applicants have found that pumping is a highly convenient way for supplying the detergent formulation to the treatment device. Pumping allows to overcome any flow resistances in the supply piping, allows to include extra equipment such as valves and flow sensors, which allows to include selection means which may select to supply one treatment device out of a plurality of treatment devices that may be connected to one pump drawing product from one discharge vessel. Pumping also provides a control mechanism for controlling the amount of product supplied during one dosing or supply transfer, in particular with a positive displacement pump, and even more appropriately with a membrane pump.

In an embodiment of the method according to the present invention, the method further comprises the step of maintaining a pressure above atmospheric in the supply connection for supplying the detergent formulation to the at least one treatment device downstream of the pump. The applicants have found that this may be provided by including a back-pressure regulator downstream of the pump. The applicants have found that maintaining the pressure above atmospheric at the pump outlet contributes particularly in increasing the reliability of the supplied amounts of the product to the treatment device.

In an embodiment of the method according to the present invention, the supplied amount of the detergent formulation is controlled by controlling the time of pumping of the at least part of the detergent formulation to the at least one treatment device, using a predetermined pump flow rate in weight for converting the required amount of detergent formulation into a time of pumping needed to supply that amount in weight. The applicants have found that this is a very convenient, accurate and highly reliable way to control the amount of product that is supplied per dosing or per supply transfer, even if the amounts to be dosed are small.

In an embodiment of the method according to the present invention wherein the supplied amount is controlled by controlling the time of pumping, the predetermined pump flow rate has been calculated using the total time of pumping that was needed to supply the at least one previous batch of the same detergent formulation and the total amount in weight of the corresponding batch registered as part of the preparation of that batch, preferably the calculation using the corresponding total time for pumping of, and the total amount of, the at least two previous batches of the same detergent formulation, more preferably the at least three previous batches, even more preferably the at least four previous batches, yet more preferably the at least five previous batches of the same detergent formulation. The applicants have found that the various elements of the apparatus collect sufficient information about the preparation and the supply of the formulation to the consumers in order to arrive at a reliable and accurate value for the flow rate, in weight, of the pump performing the supply transfer.

In an embodiment of the method according to the present invention, the method comprises the reporting of the amount in weight of the detergent formulation, preferably also of the amount of the at least one enzyme concentrate, that has been delivered during a predetermined period of time to the at least one treatment device. The applicants have found that the method provides all the information required for an accurate report of all the deliveries made to the at least one treatment device, and this in weight units and over a period of time that may comply with the needs of the owner of the apparatus and also with the owner of the at least one treatment device. It allows that the apparatus and the treatment device belong to a different legal entity and it allows for an accurate and reliable reporting of the supply of detergent formulation from the first entity to the second.

In an embodiment of the method according to the present invention, the apparatus is coupled with a server and method further comprises the step of the server receiving, analysing and transmitting data generated by the apparatus, including the amounts in weight of the detergent formulation according to the same recipe delivered to the at least one treatment device, optionally the coupling being made via the internet and/or more preferably using a wireless network. This brings the advantage that all data collection about the apparatus and about the supply of detergent formulation to the at least one treatment device may be performed remotely and without human intervention.

In an embodiment of the method according to the present invention, the method further comprises the receipt by the apparatus of signals from the server. Such signals may for instance be recipe upgrades provided by the server. Such a recipe change may however also be introduced by a control panel connected to the controller of the apparatus. The input capability may thus also be provided for manual input on-site on that control panel which may be equipped with a keyboard or other suitable input device, and/or it may be also allow for wireless input from a smartphone, tablet or personal computer handled by an operator, in which case it may also be made possible to communicate with the apparatus remotely.

In an embodiment of the method according to the present invention, the server comprises an administrator keeping track of the amounts in weights and qualities of detergent formulation actually delivered to the at least one treatment device. This brings the advantage that the accounting information is collected and stored remotely, and may be readily available to the owner of the apparatus.

In an embodiment of the method according to the present invention including the administrator, the method further comprises the calculation of the operating costs of the supplies to the at least one treatment device. Also this part of the accounting may be performed remotely and without human intervention on-site of the apparatus.

In an embodiment of the method according to the present invention, the method further comprises the step of issuing an invoice for the supplies to the operator or the at least one treatment device. Also this may be performed remotely and without human intervention on-site with the apparatus. The party consuming the detergent formulation may be invoiced for the amounts in weight of the actually supplied detergent formulation, or for the amounts in weight of the actually supplied ingredients thereof. In another embodiment the supply of the detergent formulation may be made depending on the load of the at least one treatment device. In that case, the setup of the apparatus on the site of the treatment device may comprise a “dosing system” which is informed about the amount of object that is intended for being treated by the at least one treatment device at the start of a particular washing and/or cleaning step or cycle. This amount may be expressed in weight units for a laundry wash but also in surface units for a cleaning in place operation. The dosing system may also contain information about how much of which detergent formulation should be dosed per unit of object to be treated. This information about dose per unit object to be treated may be the result of an agreement between supplier and consumer and may be different and set dependent on the classification of the object to be treated.

In an embodiment of the method according to the present invention, the invoice is issued by transferring the invoice to an administrator for the at least one treatment device. This brings the advantage that no human intervention is necessary up to and including the delivery of the invoice from the supplier of the detergent formulation to the consumer thereof.

The concentration of the enzyme concentrates in the detergent formulation may be in a very broad range. In the ultimate washing liquor, the activity of a particular enzyme concentrate ingredient may already be observed at a level of 1 ppm by weight. The inventors prefer to typically use a concentration of up to about 250 ppm by weight per enzyme concentrate in the washing liquor. The inventors further prefer to adjust the enzyme cocktail in the additive formulation and in the washing liquor to the amount and types of soil that are expected in the substrate to be treated. The ultimate washing liquor may only be obtained after injection of the detergent formulation supplied by the apparatus into the treatment device and/or after dilution of the supplied detergent formulation with water on its path from the discharge vessel to the at least one treatment device. The concentration in the detergent formulation supplied as part of the method

The concentration of a particular enzyme concentrate as part of the additive according to the present invention may be derived from the recipe that has been followed for the production of the additive. A direct measurement of the amount of an individual enzyme in the additive according to the present invention is less straightforward because with an activity test (i) only the active enzymes are participating and (ii) it is difficult to exclude the effect of other ingredients in the additive on the activity of the enzyme for which is tested.

In an embodiment of the method according to the present invention, the at least one enzyme is selected from protease, lipase, and combinations thereof. The applicants have found that these two enzymes are able to exhibit strong detergent activity. Protease may be used to attack stains of food and/or blood, while lipase may be used to attach fat stains, stains containing triglycerides.

In an embodiment of the method according to the present invention, at least one second feed source is comprising, and preferably is, a concentrate of at least one second enzyme that is capable of exhibiting detergent activity and that is different from the first at least one enzyme. This brings the advantage that the same detergent formulation may contain different types of enzymes and hence be highly active against different types of soil or stains.

In an embodiment of the method according to the present invention, the at least one enzyme comprises lipase and the lipase concentrate is preferably present in the detergent formulation in a concentration in the range of at least 0.2% wt, preferably at least 0.5% wt, more preferably at least 1.0% wt, even more preferably at least 2.5% wt, preferably at least 5.0% wt, more preferably at least 7.0% wt, even more preferably at least 8.0% wt, preferably at least 9.0% wt, more preferably at least 10.0% wt, even more preferably at least 11.0% wt, preferably at least 12.0% wt, more preferably at least 15% wt of the at least one lipase enzyme concentrate. Optionally the additive comprises at most 50% wt of the at least one lipase enzyme concentrate, preferably at most 45%, more preferably at most 40%, even more preferably at most 35%, yet more preferably at most 30%, preferably at most 27.5%, more preferably at most 25%, even more preferably at most 22.5%, yet more preferably at most 20.0% wt, preferably at most 19.0%, more preferably at most 18.0%, even more preferably at most 17.0%, yet more preferably at most 16.0% wt, preferably at most 15.0%, more preferably at most 14.0%, even more preferably at most 13.0%, yet more preferably at most 12.0% wt. The applicants prefer to arrive at a suitable balance between the cost of the amount of enzyme concentrate that is added into the detergent formulation and the effectiveness of the detergent formulation or the derivative that may be produced therefrom by adding water.

In an embodiment of the method according to the present invention, the detergent formulation comprises total proteins at a concentration of at least 5 ppm by weight, preferably at least 10 ppm by weight, more preferably at least 20 ppm, even more preferably at least 25 ppm, yet more preferably at least 30 ppm, preferably at least 35 ppm, more preferably at least 40 ppm, even more preferably at least 45 ppm, yet more preferably at least 50 ppm by weight, preferably at least 55 ppm, more preferably at least 60 ppm, even more preferably at least 65 ppm, yet more preferably at least 70 ppm by weight, preferably at least 75 ppm, more preferably at least 80 ppm, even more preferably at least 90 ppm, yet more preferably at least 100 ppm by weight, preferably at least 150 ppm, more preferably at least 200 ppm, even more preferably at least 250 ppm, yet more preferably at least 300 ppm by weight, preferably at least 400 ppm, more preferably at least 500 ppm, even more preferably at least 600 ppm, yet more preferably at least 750 ppm by weight, preferably at least 1000 ppm, more preferably at least 1500 ppm, even more preferably at least 2000 ppm, yet more preferably at least 2500 ppm by weight. The total protein concentration in the detergent formulation prepared in the apparatus and as part of the method according to the present invention may be higher if the detergent formulation is intended for being further diluted in order to obtain a washing liquor. If the detergent formulation is intended as an additive for preparing a washing and/or cleaning liquor by adding water, the formulation may contain 0.1% wt of total proteins, preferably at least 0.2% wt, more preferably at least 0.3% wt, even more preferably at least 0.4% wt, yet more preferably at least 0.5% wt, preferably at least 0.75% wt, more preferably at least 1.0% wt, even more preferably at least 2.0% wt, yet more preferably at least 3.0% wt.

Without wanting to be bound by this theory, the applicants believe that the total concentration of proteins in a composition containing enzymes expresses an upper limit for the presence of enzymes in total in the composition. However, when the composition is prepared using fairly fresh enzyme concentrates, the total protein content of the composition may be considered as a fair representation of the total enzyme concentration in the composition. The applicants therefore believe that a higher total protein concentration typically corresponds to a higher concentration of active enzymes in the composition and hence also corresponds with a higher enzymatic activity of the detergent formulation itself or a derivative obtained from it.

Optionally the detergent formulation contains at most 10% wt of total proteins, preferably at most 9% wt, more preferably at most 8% wt, even more preferably at most 7% wt, yet more preferably at most 6% wt, preferably at most 5% wt, more preferably at most 4.0% wt, even more preferably at most 3.0% wt, yet more preferably at most 2.0% wt, preferably at most 1.5% wt, more preferably at most 1.0% wt, even more preferably at most 800 ppm by weight, yet more preferably at most 600 ppm by weight, preferably at most 500 ppm by weight, more preferably at most 400 ppm by weight, preferably at most 300 ppm by weight, yet more preferably at most 250 ppm by weight, preferably at most 200 ppm by weight, more preferably at most 150 ppm by weight, preferably at most 100 ppm by weight, yet more preferably at most 80 ppm by weight. The applicants prefer to comply with the upper limit to bring the benefit of improving the cost efficiency of the detergent formulation, and this without jeopardizing the effectiveness thereof. The applicants prefer to arrive at a suitable balance between the cost of the amounts of enzyme concentrates that are added into the detergent formulation and the effectiveness of the detergent formulation or of the derivative that may be produced therefrom by adding water.

In an embodiment of the method according to the present invention, the at least one enzyme comprises protease and the protease concentrate is preferably present in the detergent formulation in a concentration in the range of at least 0.2% wt, preferably at least 0.5% wt, more preferably at least 1.0% wt, even more preferably at least 2.5% wt, preferably at least 5.0% wt, more preferably at least 7.0% wt, even more preferably at least 8.0% wt, preferably at least 9.0% wt, more preferably at least 10.0% wt, even more preferably at least 11.0% wt, preferably at least 12.0% wt, more preferably at least 15% wt of the at least one protease enzyme concentrate. Optionally the detergent formulation comprises at most 50% wt of the at least one protease enzyme concentrate, preferably at most 45%, more preferably at most 40%, even more preferably at most 35%, yet more preferably at most 30%, preferably at most 27.5%, more preferably at most 25%, even more preferably at most 22.5%, yet more preferably at most 20.0% wt, preferably at most 19.0%, more preferably at most 18.0%, even more preferably at most 17.0%, yet more preferably at most 16.0% wt, preferably at most 15.0%, more preferably at most 14.0%, even more preferably at most 13.0%, yet more preferably at most 12.0% wt. The applicants prefer to arrive at a suitable balance between the cost of the amount of enzyme concentrate that is added into the detergent formulation and the effectiveness of the detergent formulation or the derivative that may be produced therefrom by adding water.

In an embodiment of the method according to the present invention, the at least one enzyme concentrate comprises at least one amylase concentrate and wherein the amylase enzyme concentrate is preferably present in the detergent formulation at a concentration that is in a weight ratio to the concentration of the at least one lipase enzyme concentrate of at least 0.1 and at most 2.0. Preferably the weight ratio of the amylase enzyme concentrate relative to the lipase enzyme concentrate is at least preferably at least 0.20, more preferably at least 0.25, even more preferably at least 0.3, preferably at least 0.4, more preferably at least 0.5, even more preferably at least 0.55, yet more preferably at least 0.60, preferably at least 0.70. Optionally the weight ratio of the amylase enzyme concentrate relative to the lipase enzyme concentrate is at most 1.75, preferably at most 1.5, more preferably at most 1.25, even more preferably at most 1.1, preferably at most 1.0, more preferably at most 0.90, even more preferably at most 0.80, yet more preferably at most 0.70, preferably at most 0.60, more preferably at most 0.55, even more preferably at most 0.50, preferably at most 0.45, more preferably at most 0.40, even more preferably at most 0.35. The presence of the amylase enzyme brings the benefit that the detergent formulation is also active against stains of saccharides, such as starch. The applicants have further found that the compliance with this weight ratio range brings the advantage of an improved combined performance of the two kinds of enzymes, and hence an improved washing and/or cleaning performance.

In an embodiment of the method according to the present invention, the at least one enzyme concentrate comprises at least one cellulase concentrate and wherein the cellulase enzyme concentrate is preferably present in the detergent formulation at a concentration that is in a weight ratio to the concentration of the at least one lipase enzyme concentrate of at least 0.05 and at most 1.5. Preferably the weight ratio of the cellulase enzyme concentrate relative to the lipase enzyme concentrate is at least preferably at least 0.10, more preferably at least 0.15, even more preferably at least 0.20, preferably at least 0.25, more preferably at least 0.3, even more preferably at least 0.35, yet more preferably at least 0.40, preferably at least 0.50. Optionally the weight ratio of the cellulase enzyme concentrate relative to the lipase enzyme concentrate is at most 1.45, preferably at most 1.25, more preferably at most 1.10, even more preferably at most 1.00, preferably at most 0.90, more preferably at most 0.80, even more preferably at most 0.70, yet more preferably at most 0.60, preferably at most 0.50, more preferably at most 0.40, even more preferably at most 0.30, preferably at most 0.25, more preferably at most 0.20, even more preferably at most 0.15. The presence of the cellulase enzyme brings the benefit that the detergent formulation is also active in breaking down walls or organic cells, such as the construction elements of most biological specimens, single cellular and multicellular, and which thus includes all possible living creatures ranging from bacteria up to plants and meat, and hence may be key in breaking down bacteria but also rests of plants, shellfish, fish, meat, up to rests of human tissue. The applicants have further found that the compliance with this weight ratio range brings the advantage of an improved combined performance of the two kinds of enzymes, and hence an improved washing and/or cleaning performance.

In an embodiment of the method according to the present invention, the detergent formulation further comprises at least one surfactant. This brings the advantage that the detergent formulation or any derivative derived therefrom may not only be active against the substrates for which the enzymes in the formulation are active, but also against other stains on the object to be treated.

In an embodiment of the method according to the present invention, the detergent formulation comprises at least one lipase enzyme concentrate and the detergent formulation further comprises at least one amine oxide as a first surfactant, preferably an oxide of a tertiary amine, more preferably the amine oxide being an alkyl dimethyl amine oxide, even more preferably the amine oxide comprising lauryl dimethyl amine oxide and yet more preferably the amine oxide substantially being lauryl dimethyl amine oxide.

The amine oxide is preferably the oxide of a tertiary amine (R₃N⁺—O⁻), more preferably an alkyl dimethyl amine oxide, even more preferably lauryl dimethyl amine oxide (CAS 1643-20-5). Although this amine oxide is known as a high foaming surfactant, the inventors have found that the foaming may be kept acceptable by correct dosing of the amine oxide depending on the type and amounts of soil on the substrate. High soil levels, especially particulate soil types, may suppress the foaming of a washing liquor prepared with the detergent formulation in the context of the present invention that is containing the amine oxide.

In an embodiment, the detergent formulation comprises the at least one amine oxide at a concentration in the range of at least 1% wt. Preferably the detergent formulation comprises the at least one amine oxide at a concentration of at least 1.00% wt, more preferably at least 1.20% wt, even more preferably at least 1.40% wt, yet more preferably at least 1.60% wt, preferably at least 1.80% wt, more preferably at least 2.00% wt, even more preferably at least 2.20% wt, yet more preferably at least 2.40% wt, preferably at least 2.60% wt, more preferably at least 2.80% wt, even more preferably at least 3.00% wt, yet more preferably at least 3.20% wt, preferably at least 3.40% wt, more preferably at least 3.60% wt, even more preferably at least 3.80% wt, yet more preferably at least 4.00% wt, preferably at least 4.20% wt. Optionally the detergent formulation comprises the at least one amine oxide at a concentration of at most 15.0% wt, preferably at most 14.0% wt, more preferably at most 13.0% wt, even more preferably at most 12.0% wt, yet more preferably at most 11.0% wt, preferably at most 10.0% wt, more preferably at most 9.0% wt, even more preferably at most 8.0% wt, yet more preferably at most 7.0% wt, preferably at most 6.0% wt, more preferably at most 5.0% wt, even more preferably at most 4.0% wt, yet more preferably at most 3.0% wt.

The applicants have found that the choice of amine oxide as prescribed above is highly suitable for obtaining the advantageous effects on the stability and activity of the lipase enzyme in the formulation. The applicants have also found that the selected amine oxides are also more readily available in the desired quantities and in a quality that is most suitable for use in the context of the present invention.

The concentration of the at least one amine oxide, may readily be determined by High Performance Liquid Chromatography (HPLC). Also the concentration of other surfactants, such as the non-ionic surfactant and/or the alkyl polyglycoside discussed elsewhere in this document, may readily be determined using this analytical technique.

In an embodiment of the method according to the present invention, the detergent formulation comprises no surfactant other than the at least one amine oxide, except for surfactants that may have been present in the non-surfactant ingredients for preparing the detergent formulation. The applicants have found that many surfactants other than the at least one amine oxide may have a tendency to reduce the activity of the lipase enzyme when the detergent formulation is used in the context of a washing and/or cleaning operation. Without wanting to be bound by this theory, the applicants believe that this effect on the activity of a lipase enzyme may be due to the surfactant having also an affinity for the fat containing stain and may thus be in competition with the lipase enzyme for accessing the stain, thereby reducing the contact opportunities between the lipase enzyme and the fat containing stain.

In an embodiment of the method according to the present invention, the detergent formulation comprises a total of surfactants other than the at least one amine oxide in a concentration of at most 200% of the concentration of the at least one amine oxide, preferably at most 175%, more preferably at most 150%, even more preferably at most 125% and yet more preferably at most 100%, preferably at most 75%, more preferably at most 50%, even more preferably at most 25% and yet more preferably at most 10% of the concentration of the at least one amine oxide. The applicants typically prefer to not have any intentionally added other surfactants present in the detergent formulation, because of the possible negative effects that these may have on the activity of at least one of the enzymes. But they have found that such other surfactants may unintentionally be introduced as ingredient from one of the components used for the preparation of the detergent formulation. The applicants have found that limited levels of such other surfactants, as specified here, may still be allowable and allow to still achieve the technical effects targeted with the presence of the lipase enzyme and/or any one of the other enzymes. Preferably the applicants allow the presence of at least one non-ionic surfactant at levels that exceed the level as specified in this paragraph and in this feature, for reasons explained herein below.

In an embodiment of the method according to the present invention, the detergent formulation further comprises a non-ionic surfactant, preferably an ethoxylated and/or propoxylated surfactant, more preferably the ethoxylated and/or propoxylated surfactant having an average degree of alkoxylation of at most 9, more preferably at most 8, even more preferably at most 7, preferably at most 6, more preferably at most 5, and even more preferably at most 4. Optionally the average degree of alkoxylation is at least 4. The applicants have found that the presence of the specified non-ionic surfactant may be acceptable in the detergent formulation and that the desired beneficial effect on the lipase enzyme activity and stability remains achievable in the presence thereof. The presence of the second surfactant brings the advantage that the surfactant may contribute to the washing and/or cleaning performance of the detergent formulation, in particular when the detergent formulation is used as part of a washing and/or cleaning liquor. When the detergent formulation is intended for being added to a washing or cleaning liquor, the applicants prefer to dose the specified non-ionic surfactant in the detergent formulation such that its concentration in the washing or cleaning liquor becomes at most 500 ppm by weight, preferably at most 400 ppm by weight. These high concentrations may be preferred when the liquor is intended for heavy duty service, such as for washing heavily soiled textiles. The applicants have found that under these circumstances the detergent formulation is still capable of demonstrating the beneficial effect on the lipase enzyme activity. For lighter duty services of the liquor, the applicants prefer to target a lower concentration of the specified non-ionic surfactant, such as at most 350 ppm by weight, preferably at most 300 ppm by weight, more preferably at most 250 ppm by weight, even more preferably at most 200 ppm by weight, preferably at most 150 ppm by weight, and more preferably at most 100 ppm by weight. The applicants have found that the beneficial effect may under these circumstances of a lower presence of the second surfactant be even more pronounced.

In an embodiment of the method according to the present invention, the detergent formulation further comprises as a second surfactant at least one alkyl polyglycoside, preferably an alkyl polyglucoside, preferably a C8-C10 alkyl polyglucoside. The applicants have found that the alkyl polyglycoside exhibits a much lower effect on the activity of the lipase enzyme as compared to other surfactants, if any at all. The applicants have found that the advantageous effect on the lipase enzyme is much less impaired or reduced by the presence of the alkyl polyglycoside, and that in many circumstances no negative effect may be noticed at all that may be associated with the presence of the alkyl polyglycoside. The applicants have found that the dosing of the alkyl polyglycoside in the detergent formulation, and downstream into the washing and/or cleaning liquor, may be in a much wider range of concentrations as compared to the ethoxylated and/or propoxylated surfactant discussed elsewhere in this document.

In an embodiment of the present invention, the alkyl polyglycoside is having an average degree of polymerization of at most 4, preferably at most 2.5, more preferably at most 1.5. The applicants have found that the specified alkyl polyglycoside is most suitable for use in the context of the present invention, because it brings the better balance between performance as a surfactant in the washing and/or cleaning operation and any effect it may possibly bring to the activity of the enzymes in the compositions, in particular of the lipase enzyme.

In an embodiment of the present invention, the at least one alkyl polyglycoside is present as a second surfactant in the detergent formulation in a concentration of at most 25% wt. Preferably the detergent formulation comprises the second surfactant in a concentration of at least 1.00% wt, more preferably at least 1.25% wt, even more preferably at least 1.50% wt, preferably at least 1.75% wt, more preferably at least 2.00% wt, even more preferably at least 2.25% wt, preferably at least 2.50% wt, more preferably at least 2.75% wt, even more preferably at least 3.00% wt. The applicants have found that a detergent formulation comprising the second surfactant in the hereinbefore specified range is very suitable for preparing a washing liquor suitable for washing lightly soiled textiles. In another embodiment, the detergent formulation comprises the second surfactant at a concentration of at least 5% wt, preferably at least 7.50% wt, more preferably at least 10.00% wt, even more preferably at least 12.50% wt, preferably at least 15.00% wt, more preferably at least 17.50% wt, even more preferably at least 20.00% wt. The applicants have found that a detergent formulation comprising the second surfactant at this higher level is very suitable for preparing a washing liquor suitable for washing heavily soiled textiles, including even slaughterhouse textiles. Optionally the detergent formulation comprises the second surfactant at a concentration of at most 24% wt, preferably at most 23.00% wt, more preferably at most 22.00% wt, even more preferably at most 21.00% wt. Complying with the upper limit as specified brings the advantage that any possible partial hindering effect of the second surfactant on the enzyme activity remains limited, such that the beneficial effect on the lipase enzyme may be optimised in balance with the beneficial effect of having the second surfactant present in the detergent formulation, and in the downstream liquor derivative.

In an embodiment of the method according to the present invention, the detergent formulation further comprises at least one water hardness increasing compound, preferably a compound capable of liberating calcium and/or magnesium cations in an aqueous environment, preferably the water hardness increasing compound being selected from a calcium salt, a magnesium salt, and combinations thereof. Practically all salts of calcium and/or magnesium are suitable, including oxides, hydroxides, sulphates, nitrates, carbonates, bicarbonates, chlorides, formates, acetates, and the like. This embodiment is counter-intuitive because conventional washing and/or cleaning processes try to avoid water hardness, and many conventional detergent formulations contain so-called “builders”, which are components that preferably bind the calcium and/or magnesium cations such that these do not impair the activity of the surfactants in the formulation. In the context of industrial washing and/or cleaning, for that reason the operators prefer to use softened water, i.e. water from which most of the calcium and/or magnesium cations have been removed by any technique known in the art, such as ion exchange. The applicants have now surprisingly found that the lipase enzyme exhibits an even higher activity in a liquor containing a water hardness increasing compound, as compared to a liquor based on water having a low mineral content, also known as “soft water”. In order to assure the beneficial effect is achieved with the liquor prepared from the detergent formulation, the applicants prefer to add the water hardness increasing compound already into the detergent formulation.

In an embodiment of the method according to the present invention, the detergent formulation further comprises water as an ingredient, preferably at least part of the water in the detergent formulation being discard water from a rinsing step. The applicants have found that a suitable liquor for washing or cleaning, or at least a highly suitable intermediate therefore, may readily be obtained by adding water to the detergent formulation described in the context of the present invention. Preferably the applicants reuse water that was already used at least once in a rinsing step. The applicants have found that the quality of water that was already used at least once in a rinsing step is usually still acceptable for being added to the detergent formulation. The applicants realise that such rinse water may still contain surfactants that were used in the washing or cleaning step upstream of the rinsing step, but they have also found that the levels of these surfactants is typically sufficiently low such that the activity of the enzymes contributed by the detergent formulation according to the present invention still remains sufficiently high. Preferably the applicants use water obtained from a rinsing step that is part of the washing or cleaning process in which a detergent formulation as described in the context of the present invention has been used. This brings the advantage that the kind of surfactants that may be present in the water from the rinsing step is the same as the surfactants that the enzymes will encounter that are introduced into the washing or cleaning process by the detergent formulation associated with the present invention. Typically these surfactants have been selected knowing which enzymes are present in the detergent formulation. The applicants have found that this reduces the risk for a problem of incompatibility between the selection of the enzymes and the surfactants returning with the water from the rinsing step.

In an embodiment of the method according to the present invention, the batch of detergent formulation is supplied to at least one of a plurality of treatment devices, more particularly to at least two treatment devices, preferably at least three and more preferably at least four treatment devices, the treatment devices being of the same type or different.

In an embodiment of the method according to the present invention, the method is further comprising at least one washing or cleaning step wherein at least part of the detergent formulation is used in the washing or cleaning step.

In an embodiment of the method according to the present invention, the method is further comprising a prewash step, wherein the detergent formulation is used in the prewash step. The applicants have found that the detergent formulation and/or liquor derived therefrom is highly suitable for use in the prewash step. Without wanting to be bound by this theory, the applicants believe that the liquor in a prewash step contains a lower overall level of surfactants, and especially of surfactants that are not intentionally added into the liquor, and that therefore the enzymes in the liquor, in particular the lipase enzyme, experience less competition from surfactants in accessing the soil and stains they are intended to attack and remove. The applicants therefore believe that the performance of the enzymes, and in particular of the lipase enzyme, may be higher in a prewash step as compared to in a main washing step where more surfactant may be present in the liquor, possibly including surfactants that do combine less well with enzymes, in particular with a lipase enzyme.

In an embodiment of the method according to the present invention, the method is further comprising the steps of mixing the detergent formulation with water to form a liquor for washing or cleaning, and of supplying the liquor to the at least one treatment device, preferably at least part of the water used being discard water from a rinsing step, more preferably a rinsing step operated as part of a washing sequence comprising the at least one treatment device. This reuse of rinsing water brings the advantage that the overall production of discard water from the entire washing or cleaning process is reduced. All discard waters from a washing or cleaning step are contaminated and contribute to the chemical and/or biological oxygen demand of the site where the washing or cleaning process is performed, for which the society and/or authorities may request or impose a financial compensation. The reuse of at least some of the water from a rinsing step in the preparation of the detergent formulation and/or for a washing and/or cleaning liquor derived therefrom may therefore represent a reduction of the cost of operating the overall washing or cleaning operation. This optional process feature may thus readily be practiced if the detergent formulation and/or the liquor is prepared on the site where a washing step is operated.

In an embodiment of the method according to the present invention, the liquor complies with at least one and optionally all of the following conditions:
the liquor comprises at least one lipase enzyme concentrate at a concentration of at least 1 ppm and at most 500 ppm by weight, taking into account the total enzyme concentrate in its liquid form (wet basis),
the liquor comprises at least one protease enzyme concentrate at a concentration of at least 1 ppm and at most 500 ppm by weight, taking into account the total enzyme concentrate in its liquid form (wet basis),
the liquor comprises total proteins at a concentration of at least 10 ppm by weight and at most 600 ppm by weight,
the liquor comprises at least one amylase enzyme concentrate at a concentration of at least 2 ppm and at most 250 ppm by weight, taking into account the total enzyme concentrate in its liquid form (wet basis)
the liquor comprises at least one cellulase enzyme concentrate at a concentration of at least 2 ppm and at most 250 ppm by weight, taking into account the total enzyme concentrate in its liquid form (wet basis)
the liquor comprises at least one amine oxide as a first surfactant in a concentration of at least 1 ppm by weight and at most 100 ppm by weight,
the liquor comprises at least one non-ionic surfactant as a second surfactant, preferably an alkoxylated surfactant or an alkyl polyglycoside, preferably the at least one non-ionic surfactant being present in a concentration of at most 500 ppm by weight, more preferably at most 400 ppm by weight,
the liquor comprises a total of surfactants other than the at least one amine oxide and the at least one non-ionic surfactant in a concentration of at most 200% of the concentration of the amine oxide, and
the liquor comprises at least one water hardness increasing compound, preferably a compound capable of liberating calcium and/or magnesium cations in an aqueous environment, preferably the water hardness increasing compound being selected from a calcium salt, a magnesium salt, and combinations thereof.

The applicants prefer that the washing liquor should have a hardness expressed in French degrees (° fH) of at least 2° fH and at most 36° fH. Preferably the washing liquor should have a hardness of at least 3, 4, 5, 6 or 7° H. Optionally the hardness of the washing liquor should be at most 30, 25, 20, 15, 12, 10, or at most 8° fH.

In an embodiment of the method according to the present invention, the method further comprises the step of adding to the liquor an extra ingredient selected from at least one extra surfactant, such as further non-ionic surfactants, biocides, acids, builders, dispersing agents, soil release polymers, acrylates, antistatic agents, buffering agents, foaming control agents, optical brightening agents, dyestuffs, solvents, pH- adjusting agents, such as alkali, etcetera.

In an embodiment of the method according to the present invention, the liquor comprises no surfactant other than the amine oxide, except for surfactants that may have been present as a component in the non-surfactant ingredients used for preparing the liquor. Ingredients other than the additive may also contain surfactants. For instance the water that may be used as the basis for the liquor may be discard water from a rinsing step, and this water may contain some of the surfactants that were used in the washing or cleaning step upstream of the rinsing step, albeit usually at a lower concentration as compared to in the liquor that was used in the upstream washing or cleaning step. Other ingredients of the washing or cleaning liquor may also contain surfactants, e.g. in order to keep an active ingredient in emulsion or in suspension. These extra surfactants are in this embodiment of the present invention considered unavoidable impurities, because they are not intentionally added to the liquor, and its presence does not have as prime purpose a contribution to the washing and/or cleaning performance of the liquor. The applicants prefer in this embodiment to have no surfactant other than the amine oxide to be present in the liquor because this brings the advantage that the lipase enzyme encounters much less, and preferably no competition for gaining access to the fat stains the liquor is supposed to remove, and hence the lipase enzyme may exhibits its full activity, which is in addition typically boosted by the presence of the amine oxide.

In an embodiment of the present invention, the method further comprises at least one washing or cleaning step producing a treated object and wherein at least part of the liquor is used in the washing or cleaning step, preferably the washing or cleaning step being a prewash step. The applicants have found that the present invention is highly suitable for being installed and performed on-site with a washing or cleaning step, whereby the washing or cleaning step is using at least a part of the liquor prepared using the detergent formulation prepared in the apparatus and using the method according to the present invention. The enzyme-containing detergent formulation is especially suitable for being used in a prewash step, in which preferably the more difficult stains such as blood and/or fat stains are attacked prior to submitting the objects to a main wash step.

In an embodiment of the present invention, the method further comprises a main washing step producing a treated object and at least part of the liquor being used in the main washing step, preferably wherein extra surfactant is added to the washing liquor supplied to the main washing step. The liquor that may be derived from the detergent formulation prepared in the apparatus and following the method according to the present invention may also be suitable for being used in a main washing step provided the temperature and the pH of the liquor in the main washing step have remained within the range of acceptable conditions for the enzymes in the additive, preferably after adding extra surfactant to the liquor.

In an embodiment of the present invention, the method further comprises a rinsing step for producing a cleaned object, wherein discard water from the rinsing step is used in the preparation of the washing liquor and preferably also in the preparation of the detergent formulation. The benefit of such a water reuse have already been explained elsewhere in this document.

In an embodiment of the present invention wherein the method comprises a washing or cleaning step, the washing or cleaning step is part of an industrial washing process, preferably a laundry washing process, more preferably a washing tunnel. The present invention is highly suitable for being employed in the context of an industrial washing and/or cleaning process, because the improved effectiveness and the improved efficiency may bring the biggest advantages in that context, amongst others because of the sensitivities of these industrial processes explained in the background section of this document and also because of the wide range of tasks that may be requested from the washing and/or cleaning process in an industrial setting.

In an embodiment of the present invention the apparatus is used as part of a delivery system that is located on-site with the at least one treatment device. As discussed elsewhere, the proximity of the apparatus with the treatment device brings a number of highly appreciated advantages.

In an embodiment, the apparatus according to the present invention is used in the textile laundry industry, in the life sciences or pharma industry, in the food industry, in the cosmetic industry, in a hospital, and/or in the industry supplying hospitals, the food, the life sciences or the pharma industry. The applicants have found that the present invention is highly suitable for being used and employed in at least one of the industries as specified, because of the advantages the invention brings, which are highly appreciated in those industries.

The present invention is now illustrated by specific and detailed embodiments and with references to the drawings.

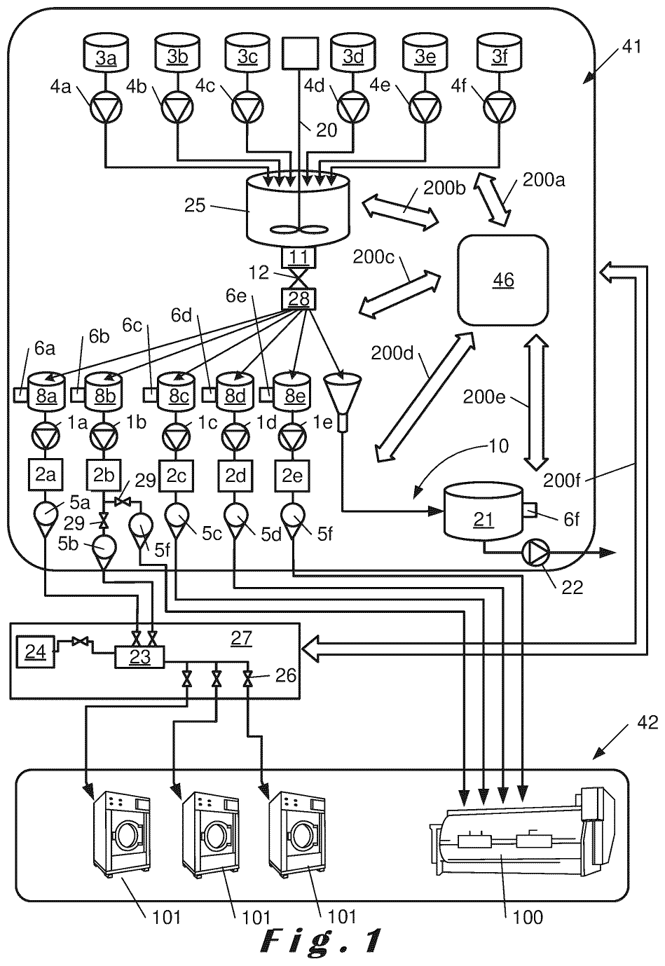

FIG. 1 shows a schematic view of an embodiment of the apparatus 41 according to the present invention and how that apparatus may be connected to a set 42 of treatment devices. The applicants point out that a wide variety of possibilities exists relating to what kind and number of treatment devices may be connected to apparatus 41, and FIG. 1 only shows one of those. In addition thereto, the overall system may even comprise a plurality of similar apparatuses 41 supplying their detergent formulations to a set of treatment devices, whereby it may be possible that some treatment devices of the set are only connected to one of the apparatuses, and other treatment devices may be supplied from more than one of the apparatuses.

In the embodiment shown in FIG. 1, the apparatus 41 comprises one mixing vessel 25, positioned on a weighing cell 11 and of which the outlet is controlled by valve 12. Feeding into mixing vessel 25 are six feed devices 4a to 4f which are membrane pumps each one being connected on the supply side to a corresponding feed source or container 3a to 3f. The mixing vessel is equipped with a stirring mechanism 20 comprising a motor and a turbine on an axis that is reaching down into vessel 25.

A detergent formulation prepared in the mixing vessel 25 may be drained from the vessel by opening valve 12 and allowing the liquid to flow into one of the destinations selected by the selection device 28 from the five discharge vessels 8a to 8e and waste disposal provision 10. The selection device 28 is provided by mounting all the discharge vessels and the inlet of the waste disposal provision on a carousel which by turning may bring the selected destination underneath the outlet of valve 12. The waste disposal provision further comprises collection pot 21 with level sensor 6f and evacuation pump 22.

Each one of discharge vessels 8a to 8e is provided with a level sensor (6a to 6e), and a membrane pump (1a to 1e) for supplying product from its corresponding discharge vessel to at least one of the treatment devices.

In the set 42 are shown as treatment devices three industrial washing extractors (WE) 101 that work in batch modus a full washing cycle, similar as those performed by a home washing or dishwashing device, and one industrial tunnel washer or continuous bulk washing machine (CBW) 100. Such a tunnel washer 100 operates in semi-continuous mode. The tunnel washer may comprise 15 or more adjacent sections that simultaneously may perform one action during a given period, after which a transport step moves the objects that were subjected to the treatment from one section to the next section. An action performed in one of the tunnel washer steps may be a step selected from the group of a prewash step, a drain step, a heating step, a main wash step, a rinsing step, an extraction step, and less typically also a centrifuging step and a drying action.

Pumps 1a to 1e are each provided with a back pressure regulator 2a to 2e and downstream thereof flow sensors 5a to 5e.

The three discharge vessels 8c to 8e are shown to each have a supply connection directly to one of three entry points in the washing tunnel 100. The two discharge vessels 8a and 8b are shown to each have an indirect supply connection to three washing extractors 101. The two pumps 2a and 2b may push liquid from their respective discharge vessels 8a and 8b into a collector 23 which is also to pull water from a dilution water supply 24. In the collector 23 the supplies from pumps 8a and 8b may be mixed and diluted with water from supply 24, after which the obtained diluted mixture may be sent via manifold 27 and valves 26 to one or more of the washing extractors 101. In addition to its indirect supply to washing extractors 101, pump 1b is also able to supply product to a fourth supply location as part of washing tunnel 100 via flow sensor 5f, provided the two valves 29 in the manifold upstream flow sensor 5f are opened and closed and a one-on-one connection is established between pump 1b and flow sensor 5f directing to tunnel washer 100.

Apparatus 41 further comprises controller 46. Controller 46 is able to perform via connections 200a to 200f the following as needed: activating pumps 4a to 4f, activating the stirring mechanism 20, receiving signals from weighing cell 11, instructing selection device 28, opening valve 12, receiving signals from level sensors 8a to 8e, activating pumps 1a to 1e, receiving signals from flow sensors 5a to 5f, instructing valves 26 and 29, receiving signals from level sensor activating pump 22.

The apparatus 41 is provided inside an enclosure (not shown) that may be locked to prevent unintended access, and which defines a closed environment for the apparatus. The enclosure is provided with a ventilation system for evacuating the content of the closed environment and which comprises a HEPA filter which filters the exhaust of the ventilation system before that is emitted to the surrounding atmosphere.

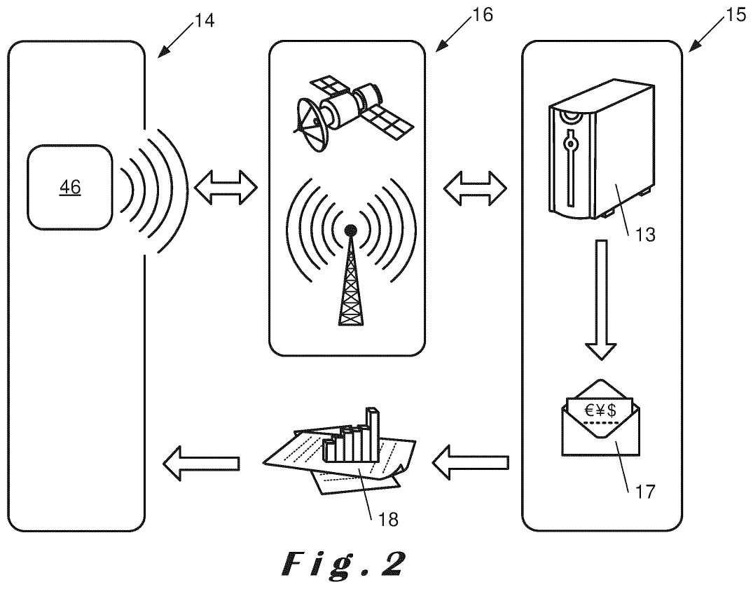

FIG. 2 shows a schematic view of a system for invoicing of an administrator 14 of a treatment device 42 by an administrator 15 of device 41. FIG. 2 shows a system in which some or all information detected by the controller 46 may be transmitted via a wireless network 16 to a server 13 of the administrator 15 of device 41, usually formed by the supplier of the bulk materials. Administrator 15 of device 41 will then be able to calculate the actual operating costs by means of server 13, and on the basis of this information the costs 17 may be charged to an administrator 14 of treatment device 42, who will receive at regular intervals an invoice 18 for the services delivered by apparatus 41 during the latest service period. This is an output-based charging of costs, wherein payment will only be made for the realized consumption. The system as shown in FIG. 2 further comprises the option for the administrator 15 of device 41 of providing the controller 46 of device 41 with diverse information, such as software updates, method improvements and so on, by means of a wireless connection 60.

The system as shown in FIG. 2 comprising device 41 therefore provides the option for administrator 15 of device 41 of monitoring the consumption of starting materials by each individual customer, such as administrator 14 of treatment device 42. The administrator 15 of device 41 hereby has the option of providing the end user proactively with starting materials when the remaining quantity of starting materials falls below a predetermined level.

### Example 1

The apparatus similar to apparatus 41 shown in FIG. 1 was installed on the site of an industrial laundry service provider. Discharge vessel 8b was connected via the set of 2 valves 29 to two tunnel washers CBW1 and CBW2. Discharge vessel 8a was connected via an extra set of valves 29a and associated flow sensors (extra to what is shown in FIG. 1) to the same two tunnel washers CBW1 and CBW2. Although exceptions could occur, CBW1 was primarily dedicated to the washing of light and middle heavily soiled laundry and CBW2 was primarily dedicated to heavily soiled and middle heavily soiled laundry.

Five (5) feed sources were made available as liquid feeds in containers 3a to 3e, according to Table 1:

TABLE 1

| Feed source | Content |
|---|---|
| 3a | Lipase concentrate |
| 3b | Cellulase concentrate |
| 3c | Amylase concentrate |
| 3d | Protease concentrate |
| 3e | Amine Oxide surfactant |

The lipase concentrate was obtained from the company Novozymes A/S (DK) under the tradename Lipex® 100 L. The lipase concentrate was a liquid having a total protein concentration of about 7% wt. The protease concentrate was a subtilisin concentrate that was obtained from the company Novozymes A/S (DK) under the tradename Coronase® 48 L. The protease concentrate was a liquid having a total protein concentration of about 8% wt. The cellulase concentrate was obtained from the company Novozymes A/S (DK) under the tradename Celluclean® 5000 L. The cellulase concentrate was a liquid having a total protein concentration of about 7% wt. The amylase concentrate was an alpha-amylase concentrate obtained from the company Novozymes A/S (DK) under the tradename Stainzyme® 12.0 L. The amylase concentrate was a liquid having a total protein concentration of about 9% wt. The amine oxide was a lauramine oxide obtained from the company Stepan under the tradename Ammonyx® LO.

The apparatus was programmed to prepare from these feed liquids a series of batches of two detergent formulations: Mix A and Mix B, according to the recipes given in Table 2. Only the ingredients listed in Table 1 were used. There was no extra water or solvent added over and above the water and/or other solvent that was introduced as part of those ingredients.

TABLE 2

| Mix | | | | | Amine |
|---|---|---|---|---|---|
| (wt %) | Lipase | Cellulase | Amylase | Protease | Oxide |
| A | X % | Y % | Z % | W % | 4.0% |
| B | 3X % | — | 3Z % | 0.5W % | 4.0% |

The applicants have found, when enzymes are required by the tunnel washers, that a wide variety of laundry classifications may appropriately be washed in a tunnel washer by dosing at least one of the two mixtures Mix A and Mix B, whereby an amount of both may be preferred for the more demanding laundries.

Based on the classification of the different batches of laundries that were supposed to be entered into the tunnel washer, the applicant developed the dosing instructions in grams per kg of treated laundry for dosing Mix A and Mix B into the respective tunnel washers as shown in Table 3. The Blue Workwear classification was not requiring any enzymes of the types available in the apparatus, and was washed without any of the two detergent formulations available in the apparatus.

TABLE 3

| | |
|---|---|
| Tunnel | Dosage in g/kg of linen |

| Washer | Linen Classification | Mix A | Mix B |
|---|---|---|---|
| CBW1 | Sheet | 0.07 | — |
| | Terry Towel | 0.09 | — |
| | Pillow Cases | 0.15 | — |
| | Table Linen | 0.22 | 0.15 |
| | Kitchen Towel | 0.65 | 0.33 |
| CBW2 | White Food Work wear | 0.55 | 0.32 |
| | Nurse Uniform | 0.27 | — |
| | Blue Workwear | — | — |
| | Roller Towel | 0.30 | 0.10 |

For each load of linen entered into each tunnel washer, the dosing system of the respective tunnel washer instructed the apparatus to dose the prescribed amounts of Mix A and/or Mix B into the prewash section of the tunnel washer corresponding to the above dosing instructions and the kg of linen in the load being processed in that prewash section.

At the end of the agreed time period, e.g. each month, the administrator of the apparatus is able to calculate the total amounts consumed of Mix A and Mix B. Using a unit price agreed between supplier and consumer, the supplier of the detergent formulations is able to issue the invoice for this consumer.

The applicants found that the above experiment, performed during one full month at the site of tunnel washers CBW1 and CBW2, was able to maintain desired washing performance while reducing the COD in the waste water from the two tunnel washers by about 25%, thanks for the reduced need for surfactants and the reduced presence of enzyme stabilisers in the two tunnel washers as compared to a month prior to the commissioning of apparatus 41, and this thanks to the appropriate dosing of the most suitable enzyme cocktail and whereby the activity of the lipase enzyme was boosted by the presence of amine oxide as the only surfactant in the detergent formulations.

### Example 2—Effect of Surfactants on Lipase Enzyme Activity

The total hydrolysis of rapeseed oil in a wash process was tested with washing liquors that were always comprising the same concentration of a lipase enzyme concentrate. A blank test was performed without any added surfactant. This blank test served as the reference with which could be compared the other results obtained with the same washing liquor samples into which one of a number of different non-ionic surfactants were added.

In the experiments, the lipase concentrate was always present in a concentration of about 0.2 gram of the concentrate per litre of total liquor. The concentrate used was obtained from Novozymes as LIPEX 100 L. The concentrate had a total protein concentration of about 9% wt, as measured using the BCA assay.

The washing liquors always had a pH of about 9.6. The washing tests were performed at a temperature of about 50° C. The water in the formulations was demineralised water obtained by reverse osmosis (RO).

Different washing liquors were prepared containing about 100 ppm by weight of a selected surfactant, to be compared with a blank liquor containing only the lipase enzyme concentrate and no surfactants.

The different surfactants tested were:
A Blank reference containing no intentionally added surfactants
B Linear Alkyl Benzene Sulphonate (LABS or also LAS)
C Lauryl ether sulphate (LES or SLES)
D 3EO-isoC13: isotridecyl alcohol ethoxylated to an average degree of ethoxylation of about 3
E 5EO-isoC13
F 7EO-isoC13
G 9EO-isoC13
H 10EO-isoC13
I C8-C10 alkyl polyglucoside (APG) with an average degree of polymerisation (DP) of 1.5.
J C8-C16 APG-DP of 1.5.
K C8-C10 APG-DP of 1.7
L 3EO-C13-C15: a mixture of linear C13-C15 alcohol that has been ethoxylated to an average degree of about 3
M 5EO-C13-C15
N 7EO-C13-15
O C9-C11 fatty alcohol alkoxylated with an average ethoxylation degree of about 6 and an average propoxylation degree of about 4.
P C12-C14 amine oxide

The above surfactants were obtained as indicated in Table 3.

TABLE 3

| Surfactant in Sample | Supplier | Under Tradename |
|---|---|---|
| B | Sasol | Marlon AS3 |
| C | Enaspol (CZ) | Hansanol NS 242 LA |
| D | BASF | Lutensol TO 3 |
| E | Sasol | Marlipal O13/50 |
| F | Sasol | Marlipal O13/70 |
| G | BASF | Lutensol TO 8 |
| H | Sasol | Marlipal O13/100 |
| I | BASF | Glucopon 215 UP |
| J | BASF | Glucopon 650EC |
| K | BASF | Glucopon 225DK |
| L | BASF | Lutensol AO 3 |
| M | BASF | Lutensol AO 5 |
| N | BASF | Lutensol AO 7 |
| O | BASF | Plurafac LF221 |
| P | PCC EXOL (PL) | ROKAnol LP3135 |

For each liquor was tested the appearance of free oleic acid generated from the hydrolysis of a standard amount of rapeseed oil with which the liquor was brought in contact. Monitored by High Performance Liquid Chromatography (HPLC) was the quantitative release of free oleic acid (C18:1 fatty acid) in the washing liquor and/or present on the textile, as explained in the protocols that are described in detail in our copending patent application having the attorney docket reference PAT2549761 EP00 and filed on the same day as this application. Because oleic acid is the main fatty acid in the triglycerides of rapeseed oil, the generation of this acid as free fatty acid it is an excellent quantitative marker for the hydrolysis of rapeseed oil, in this context thus also for the activity of the lipase enzyme.

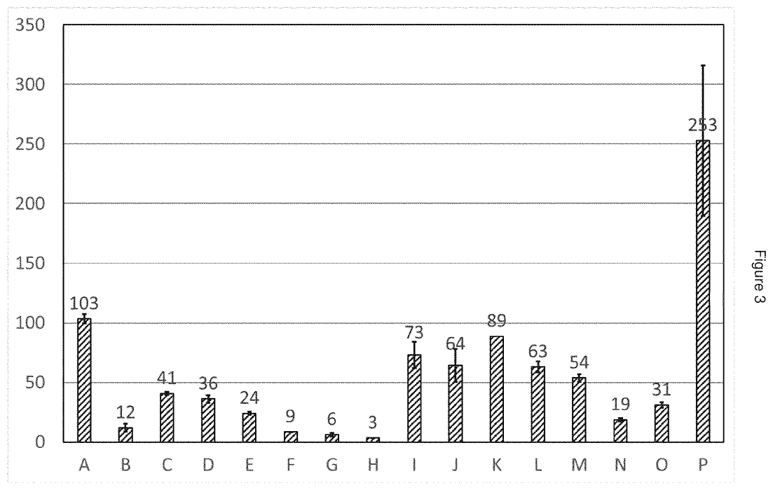

A series of tests were performed using washing liquors having a hardness of 2° fH. The results are collected and shown in FIG. 3. The bar chart shows the relative lipase activity of each liquor relative to the activity measured for the blank liquor (A) containing the same enzyme at the same concentration but no surfactants at all, which was set at 100%. For each surfactant choice 2 duplicate samples were tested, except for Sample J (3 duplicates) and Sample K (only 1 sample tested). For the blank, 5 duplicates were tested The bar chart shows the average obtained for the number of duplicates tested as represented by the bar height and the number above the bar. Also shown for each bar with a surfactant is an error bar showing the difference between the lowest and the highest of the duplicates. For the blank, the error bar shows the standard deviation calculated from the results for the five duplicates.

The results in FIG. 1 allow to make a number of important observations. The blank sample, using only the lipase concentrate arrived at producing 103 mg of oleic acid (C18:1) in the washing test.

A first observation is that most surfactants have a reducing effect on the lipase activity in the washing liquor. The most conventional surfactant used in the laundry industry (LABS—Sample B) performs very poorly because it appears to suppress the lipase enzyme activity down to a level of 12% relative to the blank. The suppressing effect of the second conventional surfactant (LES—Sample C) is less: it lands at a reduction of the lipase activity down to about 40% compared to the blank.

The most important observation is the only major exception to the rule of “suppressing lipase enzyme activity”, i.e. that the amine oxide surfactant (P) is able to bring a significant boost to the activity of the lipase enzyme.

Amongst the other surfactants, the alkyl polyglucosides (I, J, K) appear to have a much lower depressing effect as compared to the other surfactants tested. Also relatively benign are some of the ethoxylates of the linear C13-C15 alcohol (L, M), i.e. those having a 3 or 5 average degree of ethoxylation. All these surfactants (I through K) still outperform the conventional surfactants (LABS and LES, samples B and C). The 7EO version of the linear C13-C15 alcohol (sample N) is again having a much larger depressing effect. It appears that the degree of ethoxylation has become too high and the result becomes worse than the LES reference (Sample C). Sample O (the C9-C11 alcohol EO6/PO4-alkoxylate) comes out also worse than the LES reference (Sample C).

All the ethoxylates of iso-C13 alcohol (samples D, E, F, G, H) perform not better than the conventional LES surfactant (Sample C). An increasing degree of ethoxylation appears to enhance the suppressing effect on the lipase activity.

### Example 3—Effect of Surfactant Concentration

Extra experiments were performed with 5EO-isoC13 surfactant. These demonstrated that the suppressing activity already becomes noticeable at a surfactant concentration of 10 ppm by weight, that the effect further grows until the concentration of the surfactant reaches about 100 ppm by weight, but remains about the same when further increasing the surfactant presence, and this up to a concentration of 250 ppm by weight. This extra experiment demonstrated that the concentration of 100 ppm by weight of surfactant that was used in the test is expected to allow a meaningful comparison with the blank liquor.

### Example 4—Effect of Water Hardness

The effect of water hardness on the lipase activity was assessed in a series of experiments without any surfactants, with different levels of presence of the lipase enzyme concentrate and using water with different levels of hardness (expressed in French degrees hardness (° fH), as above). A series of tests were performed at lipase concentrate levels in the washing liquor of 0.01 g/litre, 0.20 g/litre and 1.00 g/litre. This series of tests were performed using RO water (0° fH), and repeated using water having a hardness of respectively 2° fH, 7° fH and 20 fH.

The tests using soft water (0° fH) showed hardly any lipase activity at all the tested levels of concentration of the lipase concentrate. Only a small concentration response of the lipase activity became noticeable with the liquor that was made using the 2° fH water. The wash liquor made with 7° fH water showed a surprisingly sharp increase when the lipase concentrate level increased from 0.01 to 0.20 g/litre, and the activity remained the same when the presence of the lipase concentrate was raised to 1.00 g/litre. The wash liquor made using the 20° fH water resulted in activity values very close to these observed at 7° fH. No further beneficial effect could be observed with the higher hardness water, but the results did also not suffer.

Having now fully described this invention, it will be appreciated by those skilled in the art that the invention can be performed within a wide range of parameters within what is claimed, without departing from the scope of the invention, as defined by the claims.

1-65. (canceled)

66. An apparatus for the on-site preparation and supply of at least one enzyme-containing detergent formulation, comprising
at least one mixing vessel for forming a batch of the detergent formulation,
at least one feed device each connected on the supply side to a feed source and on the delivery side to the at least one mixing vessel for feeding the ingredients for the detergent formulation,
at least one discharge vessel connected to the at least one mixing vessel for receiving and storing the batch of the at least one detergent formulation,
at least one discharging device provided for supplying under pressure the at least one detergent formulation stored in the at least one discharge vessel, wherein at least one of the feed sources is containing at least one enzyme concentrate comprising at least one enzyme that is capable of exhibiting detergent activity, wherein the at least one discharge device is equipped with a pump and connected on the delivery side to at least one treatment device suitable for applying the detergent formulation by treating at least one object, and the at least one discharge device is equipped for supplying upon demand at least a part of the formed batch of detergent formulation to the treatment device,
characterized in that the at least one mixing vessel is equipped with a weighing cell, capable of monitoring and signalling the weight of the at least one mixing vessel including its content, for forming the batch of the detergent formulation having a predetermined amount by weight, and comprising a predetermined amount by weight of the at least one enzyme concentrate,
wherein the at least one discharge vessel is provided with a level sensor (6a to 6e) for at least detecting a low level in the discharge vessel, and
wherein the apparatus is equipped, using the signals from the level sensor and the information from the weighing cell, for determining in weight the amounts supplied to the at least one treatment device of the at least one detergent formulation and of the at least one enzyme concentrate as part of the at least one detergent formulation.

67. The apparatus according to claim 66, wherein the at least one mixing vessel is equipped for forming the batch of the detergent formulation according to a predetermined recipe expressed by weight.

68. The apparatus according to claim 66, wherein the supply connection between the at least one discharge device and the at least one treatment device is provided with a back-pressure regulator.

69. The apparatus according to claim 68, wherein the apparatus is equipped for registering the periods of transferring time of the detergent formulation to the treatment device and for reporting the supply of the detergent formulation to the treatment device on a weight basis.

70. The apparatus according to claim 66, which is provided with a capability for communicating via an external network.

71. A method for the preparation and supply of at least one enzyme-containing detergent formulation comprising an amount of at least one enzyme concentrate as an ingredient, whereby the method is using the apparatus according to claim 66, the method comprising the steps of:
a. transferring from a plurality of feed sources the ingredients required for forming a batch of the at least one detergent formulation into a mixing vessel,
b. mixing the ingredients in the mixing vessel to form the batch of the at least one detergent formulation,
c. discharging the batch of the formed detergent formulation from the mixing vessel,
d. by pumping supplying upon demand at least a part of the batch of the at least one detergent formulation to at least one treatment device,
characterized in that at least one feed source is comprising an enzyme concentrate, in that the preparation is performed on-site with the treatment device, and in that the amounts supplied of the at least one detergent formulation and of the at least one enzyme concentrate as part of the at least one detergent formulation are determined in weight.

72. The method according to claim 71, wherein the weight of the mixing vessel including the content thereof is monitored during the transfer of the ingredients into the mixing vessel and the amounts in weight of each added ingredient is controlled and registered.

73. The method according to claim 71, wherein the detergent formulation is discharged from the mixing vessel into at least one discharge vessel and the detergent formulation is supplied from the at least one discharge vessel to the at least one treatment device.

74. The method according to claim 71, further comprising the reporting of the amount in weight of the detergent formulation that has been delivered during a predetermined period of time to the at least one treatment device.

75. The method according to claim 71, comprising the coupling of the apparatus with a server and the server receiving, analysing and transmitting data generated by the apparatus, including the amounts in weight of the detergent formulation according to the same recipe delivered to the at least one treatment device.

76. The method according to claim 71, wherein the detergent formulation comprises at least one lipase enzyme concentrate and the detergent formulation further comprises at least one amine oxide as a first surfactant.

77. The method according to claim 71, further comprising the steps of mixing the detergent formulation with water to form a liquor for washing or cleaning, and of supplying the liquor to the at least one treatment device.

78. The method according to claim 77, wherein the liquor complies with at least one of the following conditions:
the liquor comprises at least one lipase enzyme concentrate at a concentration of at least 5 ppm and at most 500 ppm by weight, taking into account the total enzyme concentrate in its liquid form,
the liquor comprises at least one protease enzyme concentrate at a concentration of at least 5 ppm and at most 500 ppm by weight, taking into account the total enzyme concentrate in its liquid form,
the liquor comprises total proteins at a concentration of at least 10 ppm by weight and at most 600 ppm by weight,
the liquor comprises at least one amylase enzyme concentrate at a concentration of at least 2 ppm and at most 250 ppm by weight, taking into account the total enzyme concentrate in its liquid form,
the liquor comprises at least one cellulase enzyme concentrate at a concentration of at least 2 ppm and at most 250 ppm by weight, taking into account the total enzyme concentrate in its liquid form,
the liquor comprises at least one amine oxide as a first surfactant in a concentration of at least 1 ppm by weight and at most 100 ppm by weight,
the liquor comprises at least one non-ionic surfactant as a second surfactant,
the liquor comprises a total of surfactants other than the at least one amine oxide and the at least one non-ionic surfactant in a concentration of at most 200% of the concentration of the amine oxide, and
the liquor comprises at least one water hardness increasing compound.

79. The method according to claim 77, further comprising at least one washing or cleaning step producing a treated object and wherein at least part of the liquor is used in the washing or cleaning step.

80. A method for employing the apparatus according to claim 66 for the preparation of at least one enzyme-containing detergent formulation by mixing the ingredients of the formulation and for supplying the at least one detergent formulation to at least one treatment device.
